(19) United States
(12) Patent Application Publication
(10) Pub. No.: US 2026/0015840 A1
(43) Pub. Date: Jan. 15, 2026

(54) WATER TREATMENT SYSTEM AND METHODS OF USE

(71) Applicant: Kohler (China) Investment Co. Ltd., Shanghai (CN)

(72) Inventors: Gaurav Kumar VERMA, Telangana (IN); Dong YAN, Shanghai City (CN); Mauricio CARVAJAL, Shanghai (CN); Vipin KUMAR, Haryana (IN)

(73) Assignee: Kohler (China) Investment Co. Ltd., Shanghai (CN)

(21) Appl. No.: 18/993,832

(22) PCT Filed: Jul. 15, 2022
(86) PCT No.: PCT/CN2022/106085

§ 371 Date: Jan. 13, 2025

(51) Int. Cl. E03C 1/04; C02F 1/00; E03C 1/05

(52) U.S. Cl. CPC E03C 1/0412; C02F 1/008; E03C 1/055; C02F 2201/005; C02F 2209/006; C02F 2209/02; C02F 2209/03; C02F 2209/40; C02F 2301/043; C02F 2307/06

(57) ABSTRACT

A faucet system (100) is provided. The faucet system (100) includes a fixture (102), a hose extending through the fixture (102), and an enhancement module (222) removably coupled to the hose and extendable and retractable from the fixture (102). The fixture (102) includes a base (110) configured for coupling to a mounting surface (101) and includes a neck (112) coupled to the base (110). The hose extends through the neck (112) and the base (110) and the hose includes a handle portion (220) coupled to an end of the hose. The enhancement module (222) is removably coupled to the handle portion (220) and is configured to receive a flow of water from the hose and selectively provide a treatment to the flow of water.

### BACKGROUND

The present disclosure relates generally to water fixtures. More specifically, the present disclosure relates to water treatment systems for providing a treatment to a flow of water and providing the flow of water to a fixture.

### SUMMARY

At least one embodiment relates to a faucet system. The faucet system includes a water treatment system, a fixture fluidly coupled to the water treatment system, and a user interface controller communicatively coupled to a system controller of the water treatment system. The water treatment system includes the system controller and a treatment device configured to selectively provide a treatment to a flow, the treatment device being in communication with the system controller. The fixture is configured to receive a flow of water from the water treatment system. The user interface controller is configured to send a first input to the system controller, the first input comprising instructions for operating the treatment device, and the user interface controller is further configured to send a second input to the system controller, the second input causing initiation of the flow of water through the fixture, and causing operation of the treatment device according to the instructions of the first input.

Another embodiment relates to a faucet system. The faucet system includes a fixture, a treatment device, a user interface controller, and a system controller in communication with the fixture, the treatment device, and the user interface controller. The fixture includes a handle controller in communication with the system controller and includes a spray head having an outlet and configured to discharge a flow of water. The treatment device is in fluid communication with the spray head and is configured to selectively output a treatment to a flow of water. The system controller is configured to receive a first signal from the user interface controller; in response to receiving the first signal, determine whether to activate the treatment device in response to receipt of a second signal; receive the second signal from the handle controller; and in response to receiving the second signal, operate the faucet system to do at least one of the following: discharge an untreated flow of water from the fixture; activate the treatment device and discharge a treated flow of water from the fixture; or discharge an untreated flow of water from the fixture for a first time interval, activate the treatment device at an end of the first time interval, and discharge a flow of treated water from the fixture for a second time interval.

Another embodiment relates to a faucet system. The faucet system includes a fixture, a hose extending through the fixture, and an enhancement module removably coupled to the hose and extendable and retractable from the fixture. The fixture includes a base configured for coupling to a mounting surface and includes a neck coupled to the base. The hose extends through the neck and the base and the hose includes a handle portion coupled to an end of the hose. The enhancement module is removably coupled to the handle portion and is configured to receive a flow of water from the hose and selectively provide a treatment to the flow of water.

Another embodiment relates to a water treatment system. The water treatment system includes a treatment device, a valve assembly, and a system controller. The treatment device is configured to selectively provide a treatment to a flow of water. The valve assembly is configured to stop and start the flow of water through the water treatment device. The controller is communicatively coupled to both the treatment device and the valve assembly. The system controller includes a processor and a memory, the memory structured to store instructions that are executable by the processor and cause the controller to: receive a first input from a user interface device; in response to receiving the first input, configure an operating status of the treatment device, the operating status being one of a dormant status and a stand-by status; receive a start flow input from a user interface device; and in response to the start flow input: operate the valve assembly to start the flow of water; and operate the treatment device according to the operating status; where in the dormant status, the treatment device is powered off in response to the second input; and in the stand-by status, the treatment device is activated and provides an input to the flow of water in response to the start flow input.

This summary is illustrative only and should not be regarded as limiting.

### BRIEF DESCRIPTION OF THE FIGURES

The disclosure will become more fully understood from the following detailed description, taken in conjunction with the accompanying figures, wherein like reference numerals refer to like elements, in which:

FIG. 1 is a side, cross-sectional view of a faucet system, according to an example embodiment;

FIG. 2 is a perspective view of a fixture of the faucet system of FIG. 1;

FIG. 3 is a perspective view of the fixture of FIG. 2 in an extended position;

FIG. 4 is a perspective view of an enhancement module of the faucet system of FIG. 1;

FIG. 5 is a cross-sectional view of the enhancement module of FIG. 4, according to an example embodiment;

FIG. 6 is a cross-sectional view of the enhancement module of FIG. 4, according to another example embodiment;

FIG. 7 is a cross-sectional view of the enhancement module of FIG. 4, according to another example embodiment;

FIG. 8 is a cross-sectional view of an enhancement module, according to an example embodiment;

FIG. 9 is a perspective view of an enhancement module, according to an example embodiment;

FIG. 10 is a cross-sectional view of the enhancement module of FIG. 9;

FIG. 11 is a cross-sectional view of an enhancement module, according to another example embodiment;

FIG. 12 is an example embodiment of an enhancement module, according to another example embodiment;

FIG. 13 is a cross-sectional view of a faucet system, according to an example embodiment;

FIG. 14 is a cross-sectional view of a faucet system, according to another example embodiment;

FIG. 15 is a top view of a user control interface of a faucet system, according to an example embodiment;

FIG. 16 is a top view of the user control interface of FIG. 15 in a different configuration;

FIG. 17 is a side view of a water treatment system of a faucet system, according to an example embodiment;

FIG. 18 is a perspective view of a user interface control coupled to a fixture, according to an example embodiment;

FIG. 19 is a perspective view of a user interface control coupled to a fixture, according to another example embodiment;

FIG. 20 is a perspective view of a user interface control coupled to a fixture, according to another example embodiment;

FIG. 21 is circuit diagram of a controller of the faucet system of FIG. 1;

FIG. 22 is a block diagram of a method of controlling the faucet system of FIG. 1, according to an example embodiment;

FIG. 23 is a perspective view of a faucet system, according to an example embodiment;

FIG. 24 a perspective view of a steam wand of the faucet system of FIG. 23;

FIG. 25 is a detailed perspective view of the steam wand of FIG. 24;

FIG. 26 is a detailed view of a fitting of the faucet system of FIG. 23;

FIG. 27 is a detailed view of an enhancement module of the faucet system of FIG. 23 being coupled to the fitting of FIG. 26;

FIG. 28 is a side view of the faucet system of FIG. 23 is an extended configuration;

FIG. 29 is a detailed perspective view of the enhancement module as a scrubbing module;

FIG. 30 is a detailed perspective view of the scrubbing module having a replaceable circular brush;

FIG. 31 is a detailed perspective view of the scrubbing module having a bottle brush; and

FIG. 32 is a flow diagram of a water treatment system of a faucet system, according to an example embodiment.

### DETAILED DESCRIPTION

Before turning to the FIGURES, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

Referring generally to the FIGURES, a water treatment system is provided. The water treatment system is configured to receive a flow of water, selectively provide a treatment to the flow of water, and provide the flow of water to a fixture. The water treatment system includes a treatment device operably coupled to a controller. The treatment device is configured to selectively provide a treatment to a flow of water flowing through the water treatment system. The treatment device treats the flow of water to create one of ozonated water, steam, hot water, filtered water, microbubbles, nanobubbles, electrolyzed water, water having a concentrate (e.g., soap, cleaning concentrate, etc.) and pH-adjusted water (e.g., water above 7 pH, water above 10 pH, water below 7 pH, water below 3 pH, etc.). In some embodiments, the flow of water is treated by two different treatment devices such that the flow of water receives two different treatments. The water treatment system is user-programmable such that a treatment setting is established before a flow of water is initiated through the fixture. A user interaction with a user interface controller sends instructions to the controller for operating the treatment device. For example, if a user would like to discharge ozonated water with a concentration of two parts-per-million (e.g., 2 PPM), the user engages with the user interface controller to provide the system controller with instructions for how to operate the treatment device while water is flowing through the fixture. The instructions include a status (“active” or “inactive”), a setting (e.g., concentration, PPM, etc.), and a delay (e.g., time delay before providing treatment to the fluid). Through the user interface control, the user may set the treatment device, in this case the ozone generator, to “on” with 2 PPM. Upon detection that the treatment device is an ozone generator, the controller may automatically apply a pre-set time delay. In some embodiments, such as when the treatment device provides soap to a flow of water, the time delay may be programmable by the user interface controller. After the user has sent the treatment device operating instructions to the controller, the user interacts with a start controller to simultaneously begin a flow of water through the fixture and begin execution of the treatment device operating instructions. In some embodiments, the start controller is part of the user interface controller. In some embodiments, the start controller is a handle or button on the fixture. In some embodiments, the start controller is a control puck physically separate from, but operably coupled to, the water treatment system and the fixture.

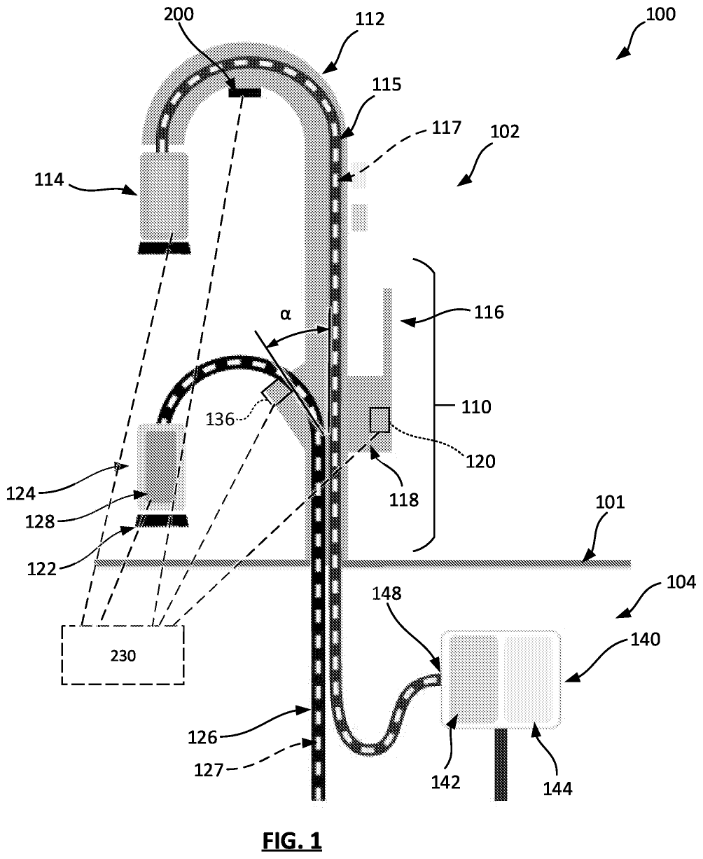

Turning now to FIG. 1, a faucet system 100 is shown, according to an example embodiment. The faucet system 100 includes a fixture (e.g., faucet) 102 and a water treatment system 104 fluidly coupled to one another. The water treatment system 104 is configured to receive a flow of water (such as from municipal supply lines), selectively provide a treatment to the flow of water, and provide the flow of water to the fixture 102. In some embodiments, the water treatment system 104 provides a treatment to the flow of water before providing the treated flow of water to the fixture 102. In some embodiments, the water treatment system 104 provides the flow of water to the fixture 102 before treating the flow of water. For example, the water treatment system 104 may provide the flow of water to a mixing valve in the fixture 102 before treating the flow of water. The fixture 102 is configured for coupling to a mounting surface 101, such as a countertop, a sink, a wall, a floor, or any other surface where having the fixture 102 is desirable. As shown in FIG. 1, the water treatment system 104 is positioned on an opposite side of the surface 101 from the fixture 102. For example, in embodiments where the fixture 102 is a sink faucet that is in fluid communication with a sink, and where the surface 101 is a countertop, the water treatment system 104 may be positioned below the surface 101 and within a cabinet space. In some embodiments, such as when the fixture 102 is a shower head and the surface 101 is a wall, the water treatment system 104 may be positioned behind the wall and out of sight of a user of the fixture 102. In some embodiments, such as when the fixture 102 is a spigot in fluid communication with a bath tub and the surface 101 is a floor, the water treatment system 104 may be positioned below the floor and out of sight of the user. In some embodiments, the water treatment system 104 is easily accessible and visible such that maintenance and repair of the water treatment system 104 is possible without accessing service panels or crawl spaces. In some embodiments, the water treatment system 104 is intentionally visible to the user of the fixture 102 for a desirable aesthetic effect.

As shown in FIG. 1, the fixture 102 is a faucet. The fixture 102 includes a base 110, a neck 112, and a first spray head 114. The base 110 is coupled to the surface 101, the neck 112 is rotatably coupled to the base 110, and the first spray head 114 is selectively and/or removably coupled to the neck 112. In some embodiments, the surface 101, the base 110, the neck 112, and the first spray head 114 are rotatably coupled, selectively coupled, removably coupled, or any combination thereof, to one another. The base 110, the neck 112, and the first spray head 114 are in fluid communication with one another such that the flow of water provided to the base 110 by the water treatment system 104 is discharged by the first spray head 114. Specifically, a first fluid conduit 115 fluidly couples the first spray head 114 to the water treatment system 104. The first fluid conduit 115 may be a retractable spray hose that retracts into the neck 112 and the base 110 of the fixture 102. The fixture 102 is configured to receive a treated flow of water from the water treatment system 104, such as steam, hot water, filtered water, microbubbles, nanobubbles, ozonated water, electrolyzed water, hydrogen water, and pH water (e.g., water above 7 pH, water above 10 pH, water below 7 pH, water below 3 pH, etc.). In some embodiments, the fixture 102 provides an untreated flow of water. As used herein the term “flow of water” refers to both a treated flow of water and an untreated flow of water unless specifically indicated otherwise.

The first fluid conduit 115 includes a first electrical conduit 117 extending along the length of the first fluid conduit 115 and configured to provide power and data to the first spray head 114.

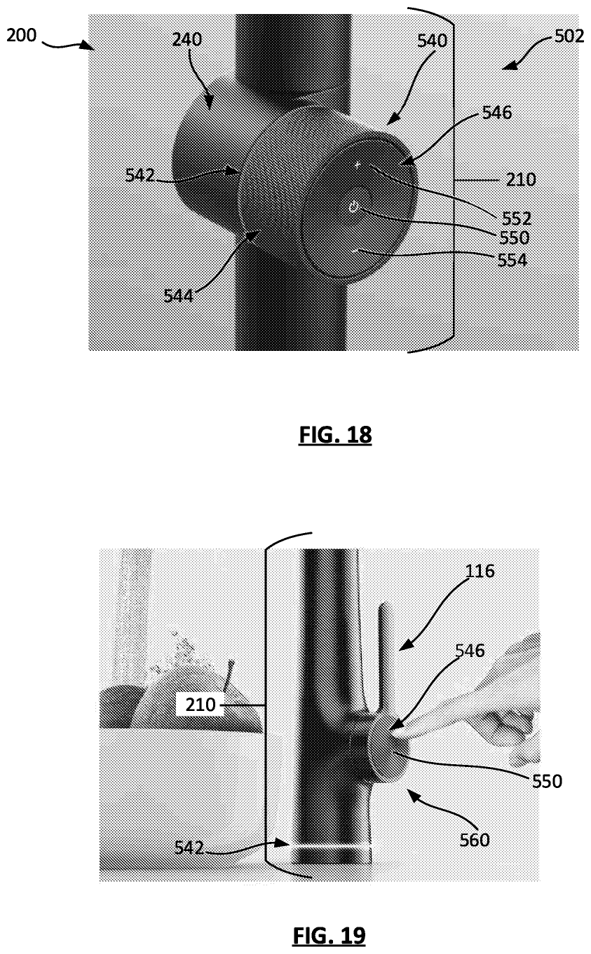

The fixture 102 further includes a handle control 116 operably coupled to a mixing valve 118. In some embodiments, as shown in FIG. 1, the handle control 116 and the mixing valve 118 are coupled to the base 110. Operation of the handle control 116 operates the mixing valve 118 to start, stop, and further control a flow of water through the fixture 102 and to the first spray head 114 via the first fluid conduit 115. In some embodiments, the mixing valve 118 and the handle control 116 are physically separate and the handle control 116 is operably coupled to the mixing valve 118 such that an interaction with the handle control 116 operates the mixing valve 118. In some embodiments, the faucet system 100 incudes a digital mixing valve that is wirelessly controlled such that the handle control 116 may be physically separated from the mixing valve 118, the fixture 102, or both while still controlling operation of the mixing valve 118. In some embodiments, the base 110 includes the user interface controller 200 configured to send instructions to a system controller 230 for operating the water treatment system 104. In some embodiments, the user interface controller 200 is a button or sensor positioned on the neck 112 and configured to operate a portion of the water treatment system 104 is response to receiving an engagement from the user. In some embodiments, the handle control 116 is the user interface controller 200. In some embodiments, the base 110 includes a dial, a toggle, or a similar control feature instead of, or in addition to, the handle control 116 (FIGS. 18-20). In some embodiments, the handle control 116 includes a sensor, shown as a handle sensor 120, in communication with the system controller 230 and configured to detect the position of the handle control 116. For example, when the handle control 116 is in the off position, the handle sensor 120 may send a signal to the system controller 230 to power off a portion of the faucet system 100 (e.g., a water treatment system, a water treatment device, etc.). When the handle control 116 is in an on position (e.g., a position other than the off position), the handle sensor 120 may send a signal to the system controller 230 to activate a portion of the faucet system 100. For example, in embodiments where the water treatment system 104 is configured to generate bubbles (e.g., microbubbles, nanobubbles, etc.) in a flow of water, detection by the handle sensor 120 that the handle control 116 is not in the off position may automatically activate a bubble generator that creates bubbles in the flow of water.

In some embodiments, as shown in FIG. 1, the fixture 102 includes a second spray head 124 configured to receive a flow of water from a second fluid conduit 126. The second fluid conduit 126 may include a second electrical conduit 127 that is configured to provide power, data, or both to the second spray head 124. The second spray head 124 may be removably coupled to the base 110 and extendable and retractable into the base 110. In some embodiments, the mixing valve 118 controls a flow of water to both the first spray head 114 and the second spray head 124. In some embodiments, the first fluid conduit 115 and the second fluid conduit 126 are fluidly isolated such that the mixing valve 118 is a first mixing valve 118 and operation of the handle control 116 does not control a flow of water to the second spray head 124. In some embodiments, the second spray head 124 is a steam module 128 having a steam device configured to receive a flow of water and discharge a flow of steam from the second spray head 124. The second spray head 124 may further include a brush 122 positioned at an end of the second spray head 124 proximate to an outlet of the second spray head 124. In some embodiments, the second spray head 124 is removably coupled to the second fluid conduit 126 such that the second spray head 124 can be replaced with a different module, such as an electrolyzing module.

The second spray head 124 is operable between a docked position and an undocked position. In some embodiments, the base 110 includes a dock sensor 136 structured to detect whether the second spray head 124 is in the docked position. The dock sensor 136 is configured to send a signal to the system controller 230 indicating the docking position of the second spray head 124 relative to the base 110. For example, if the second spray head 124 is in the docked position, the dock sensor 136 will send a signal to the system controller 230, and the system controller 230 may prevent the steam mode from being operated. This may be a safety feature to prevent splashing of hot water and accidental turn on while the second spray head 124 is not being used. In some embodiments, the system controller 230 “pulls” a signal from the dock sensor 136 in response to a condition or change in condition. For example, if the user interface controller 200 is operated by a user to turn on the steam function, the system controller 230 will request a signal from the dock sensor 136 indicating the position of the second spray head 124. If the dock sensor 136 sends a signal to the system controller 230 that the second spray head 124 is undocked, the system controller 230 will active the steam function.

The faucet system 100 further includes a reservoir module 140. The reservoir module 140 is configured to store a fluid and provide the fluid to the first spray head 114, the second spray head 124, or both. The reservoir module 140 includes a plurality of modules, including a first reservoir 142 and a second reservoir 144. The first reservoir 142 may be fluidly isolated from the second reservoir 144 to prevent mixing between the first reservoir 142 and the second reservoir 144. The first reservoir 142 may include a treated volume of water, such as soapy water, electrolyzed water, ozonated water, soapy water, steam, water with nanobubbles, water with microbubbles, filtered water, water with a cleaning concentrate, and the like. In some embodiments, the first reservoir 142 includes a cleaning concentrate. Similarly, the second reservoir 144 may include soapy water, electrolyzed water, ozonated water, soapy water, steam, water with nanobubbles, water with microbubbles, filtered water, a cleaning concentrate, and the like. In some embodiments, the first reservoir 142 and the second reservoir 144 are configured to mix downstream from the first reservoir 142 and the second reservoir 144. For example, the reservoir module 140 may include a reservoir valve assembly 148 in fluid communication with both the first reservoir 142 and the second reservoir 144. In response to a request from the user interface controller 200 to receive a flow of water from the first reservoir 142, the reservoir valve assembly 148 may receive a flow of water from the first reservoir 142 and provide the flow of water to the fixture 102. In some embodiments, the reservoir valve assembly 148 may receive a command to provide a flow of water having both nanobubbles and a cleaning concentrate. Accordingly, the reservoir valve assembly 148 may receive a flow of water from both the first reservoir 142 and the second reservoir 144, combine the two flows of water, and provide the combined flow of water to the fixture 102. The reservoir module 140 may be positioned below the surface 101 to prevent the reservoir module 140 from taking up space on or above the surface 101.

As shown in FIG. 1, the second spray head 124 and the second fluid conduit 126 are shown fluidly isolated from the reservoir module 140. For example, in embodiments where the second spray head 124 is a dedicated steam module (e.g., the steam module 128), it may be desirable for the second fluid conduit 126 to be fluidly coupled directly to a hot water supply line upstream from the reservoir module 140. In some embodiments, the second fluid conduit 126 is fluidly coupled to the reservoir module 140 and the reservoir valve assembly 148 such that the second spray head 124 can receive a flow of water from the reservoir module 140 via the reservoir valve assembly 148. In some embodiments, the second fluid conduit 126 is an insulated conduit configured to prevent significant heat losses from a hot flow of water (water exceeding 120° F., or 49° C.) flowing through the second fluid conduit 126. The second fluid conduit 126 is extendable and flexible such that the second spray head 124 may be removed from the base 110 and manipulated to spray in multiple angles. When the second spray head 124 is in the docked position, the second spray head 124 may extend away from the base at an angle α. The angle α is between 30° and 60°.

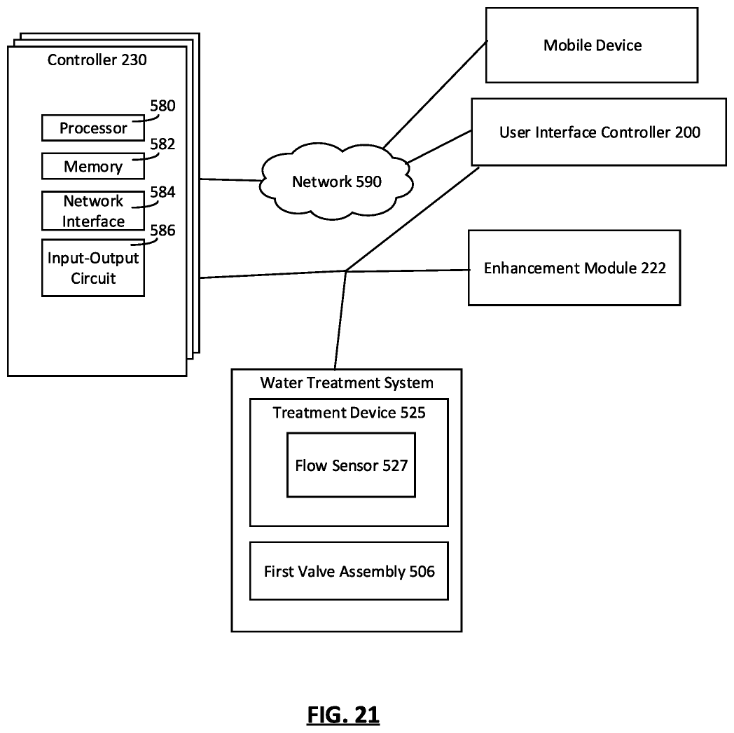

The fixture 102 is operable by a user to provide one or more flows of water upon interaction with the user interface controller 200. The user interface controller 200 may be a physical actuator (e.g., button, switch, sensor, interactive screen, wireless remote, etc.) or a virtual actuator (e.g., voice command, etc.). In some embodiments, the user interface controller 200 is a wireless control puck, a touch screen, a remote, and the like. The user interface controller 200 sends a signal to the system controller 230 (FIG. 21) of the faucet system 100. The system controller 230 is configured to detect a condition (e.g., temperature, flow rate, etc.) and complete an action in response to detection of that condition. For example, in order for a user to operate the user interface controller 200 to use the steam function, the system controller 230 may detect whether the second spray head 124 is docked with (e.g., removably coupled to) the base 110. If the second spray head 124 in not docked, the system controller 230 may prevent operation of the steam function. In some embodiments, in response to the system controller 230 detecting that the second spray head 124 is in the docked position, the system controller 230 may disable the user interface controller 200 such that an interaction with the user interface controller 200 does not activate (or send a signal to the system controller 230 to activate) a flow of steam from the steam module 128. It should be understood that the aforementioned example of the system controller 230 is not limiting, and that the system controller 230 may be configured to detect multiple conditions before completing an action. In some embodiments, preventing an action from occurring is equivalent to completing and action (e.g., actively disabling the user interface controller 200, preventing the temperature of the water exiting the first spray head 114 from changing, etc.).

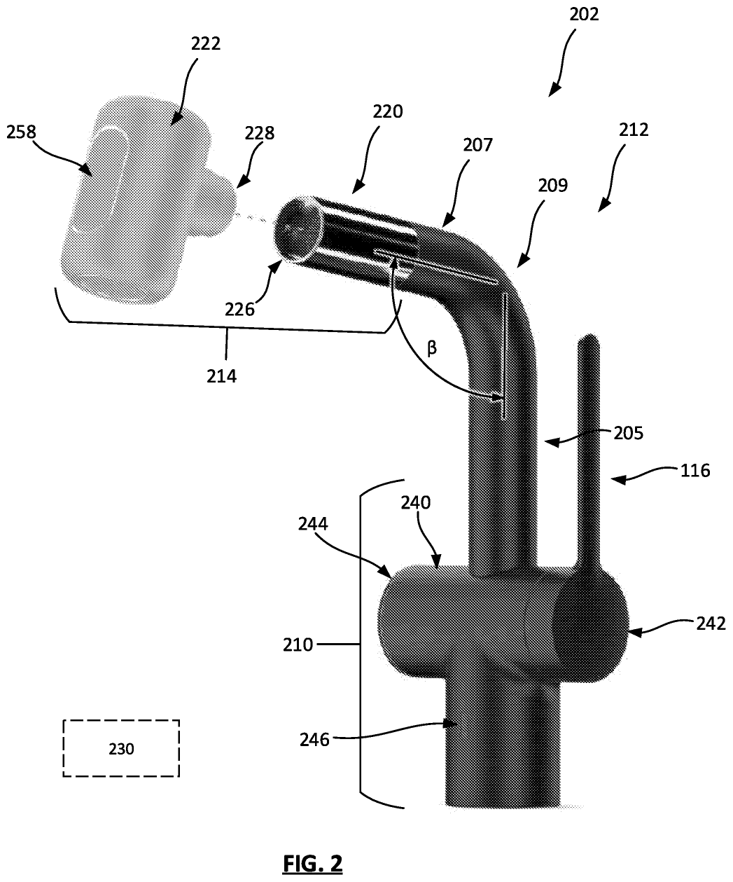

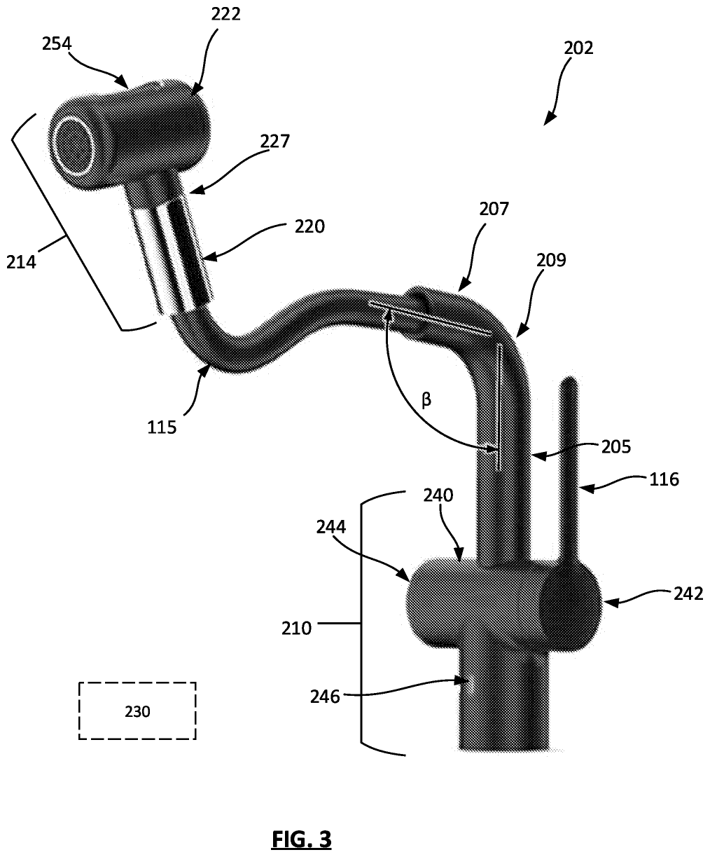

Referring now to FIGS. 2 and 3, a fixture 202 is shown, according to another example embodiment. The fixture 202 is similar to the fixture 102. Accordingly, like numbering is used to denote likes parts between the fixture 102 and the fixture 202. A difference between the fixture 102 and the fixture 202 is that the fixture 202 has an overall different aesthetic when compared to the fixture 102, including a base 210 and a neck 212 having a different structure from the base 110 and the neck 112.

The neck 212 includes two portions, shown as a first neck portion 205 that is coupled to the base 210 and a second neck portion 207 that is coupled to the first spray head 214. The first neck portion 205 and the second neck portion 207 meet (e.g., are coupled to one another) at a bend 209 having an obtuse angle β (e.g., and angle greater than 90 degrees). In some embodiments, the first neck portion 205 and the second neck portion 207 meet at a right angle (e.g., angle of approximately) 90°. The neck 212 may be cylindrical and have a circular cross-sectional shape. In some embodiments, the angle β is acute (e.g., less than 90 degrees).

The first spray head 214 (e.g., spray head) includes two portions, shown as a handle portion 220 and an enhancement module 222. The handle portion 220 is removably coupled to the second neck portion 207 (FIG. 3) and receives a flow of fluid from a water treatment system (e.g., the water treatment system 104) via the first fluid conduit 115. In some embodiments, the handle portion 220 is substantially cylindrical and has the same cross-sectional shape as the neck 212. The handle portion 220 is structured to be gripped by a user and may include gripping features, such as bumps, knurling, overmolded features, and the like.

The enhancement module 222 is removably coupled to the handle portion 220, such as with a threaded coupling, a bayonet fastening, latches, magnets, an interference fit, and the like. In some embodiments, the enhancement module 222 is integrally formed with the handle portion 220. As utilized herein, two or more elements are “integrally formed” with each when the two or more elements are formed and joined together as part of a single manufacturing process to create a single-piece or unitary construction that cannot be disassembled without an at least partial destruction of the overall component.

The handle portion 220 includes a handle fitting 226 configured for coupling with a module fitting 228 of the enhancement module 222. The fittings 227 (e.g., the handle fitting 226 and the module fitting 228) are structured to selectively and fluidly couple the handle portion 220 to the enhancement module 222. In some embodiments, the fittings 227 are further structured to communicatively couple the handle portion 220 to the enhancement module 222 together such that the enhancement module 222 is in communication with the system controller 230. For example, the fittings 227 may include an electrical connection configured to transfer data and power between the enhancement module 222 and the system controller 230 of the faucet system 100. The enhancement module 222 includes a module interface 258 (e.g., button, switch, control switch, sensor, toggle, etc.) in a position for interaction by a user. An engagement of the module interface 258 by the user may send a signal to the system controller 230 to change an operating condition of the enhancement module 222. In some embodiments, the module interface 258 includes multiple engagement portions (e.g., buttons and switches) that may be operated by the user to change, for example, an output spray mode of the enhancement module 222, a condition of the faucet system 100, and the like. In some embodiments, the user interface controller 200 is operated by the user to change a mode of the enhancement module 222.

In some embodiments, the enhancement module 222 includes a closed-loop controller system that is communicatively isolated from the rest of the faucet system 100. For example, the fittings 227 may be structured to provide power, but not data (e.g., signals), such that the system controller 230 is not in communication with the enhancement module 222. Therefore, the enhancement module 222 is operated independently of the faucet system 100. This may be desirable where compatibility between the enhancement module 222 and the system controller 230 is challenging, such as with the use of third-party enhancement modules that were not manufactured by the manufacturer of the fixture 202.

In some embodiments, the enhancement module 222 is a bubble module configured to form bubbles in a flow of water. In embodiments where the bubble module includes a closed-loop controller and is communicatively isolated from the rest of the faucet system 100, the bubble module is controlled without affecting the operation of the faucet system 100. Another advantage of providing a closed-loop control system in the enhancement module 222 is that the faucet system 100 and the system controller 230 may not require firmware and software updates in order to be compatible with newer modules, since the fittings 227 are only communicating power and not data. In some embodiments, the enhancement module 222 includes a computer connection (universal serial bus, serial, etc.) configured for communicatively connecting to a computer or other computing device such that software related tasks, such as updating the spray modes of the enhancement module 222, can be completed without having to operate a separate controller (e.g., system controller 230) associated with the rest of the faucet system 100. In some embodiments, the enhancement module 222 is configured for wireless communication with a computing device, such as a cell phone, so that software and firmware updates are enabled wirelessly.

The enhancement module 222 may complete a variety of tasks and have multiple operating modes. In some embodiments, the enhancement module 222 is configured to provide a first treatment to a flow of water, and a second enhancement module is required to provide a second treatment to a flow of water. In some embodiments, the enhancement module 222 receives a treated flow of water from the water treatment system and the enhancement module 222 provides a second treatment to the flow of water. A user may desire multiple types of water treatment and therefore acquire multiple enhancement modules, each of the enhancement modules providing a different treatment to a flow of water. In some embodiments, the enhancement module 222 includes an ozone generator (e.g., corona discharge ozone generator, UV light ozone generator, venturi ozone generator, etc.). In some embodiments, the enhancement module 222 includes an electrolytic device configured to electrolyze the water flowing through the enhancement module 222. The electrolytic device may be configured to change the pH of the flow of water flowing through the enhancement module 222. In some embodiments, the enhancement module 222 incudes a bubble generator (e.g., microbubble generator, nanobubble generator, etc.). In some embodiments, the enhancement module 222 is configured to provide a cleaning solution (e.g., soap, detergent, concentrate, etc.) into a flow of water. In some embodiments, the enhancement module 222 is configured to convert a flow of water into a flow of steam. In some embodiments, the enhancement module 222 includes a scrubbing device (e.g., the scrubbing device 288) having an actuator (e.g., the actuator 290, motor, etc.) and the brush 122. In some embodiments, the scrubbing device is configured to oscillate and/or rotate the brush 122 to provide an improved scrubbing experience. In some embodiments, the scrubbing device receives power via the fittings 227. In some embodiments, the brush 122 is coupled to the enhancement module 222 and is not configured to move independently from the enhancement module 222. In some embodiments, the scrubbing device is an additional feature included with, for example, the bubble generator, the ozone generator, and similar treatment devices.

The fixture 202 further includes the handle control 116 and the user interface controller 200 coupled to the base 210. The base 210 includes a substantially cylindrical control body 240 positioned orthogonal to the base 210 and orthogonal to the neck 212. The control body 240 includes a first end 242 and a second end 244. The handle control 116 is coupled to the control body 240 proximate to the first end 242. The user interface controller 200 may be coupled to the control body 240 opposite to the handle control 116 and proximate to the second end 244. The user interface controller 200 is engagable by the user to send instructions to the system controller 230 for operating the enhancement module 222 in response to detecting that the handle control 116 is positioned out of the off position. Specifically, while the handle control 116 is in the off position, a user may engage the user interface controller 200 to provide instructions to the system controller 230 for how to operate the faucet system 100, and specifically the enhancement module 222, in response to the handle control 116 being moved out of the off position. In some embodiments, the system controller 230 disables the user interface controller 200 in response to detecting that the handle control 116 is moved out of the off position.

The user interface controller 200 may include capacitive touch sensors, push buttons, dials, toggles, switches, and the like. In some embodiments, the user interface controller 200 includes an LCD screen for displaying a condition of the water treatment system 104. For example, if the user interface controller 200 is operated to send instructions to the system controller 230 to activate a treatment device in response to detecting that the handle control 116 is not in the off position, the LCD screen may display an image, numbers, words, or some other indicator that the treatment device of the enhancement module 222 is a standby mode and ready for activation in response to an input received by the handle control 116 (e.g., moving the handle control 116 out of the off position).

The fixture 202 further includes a fixture indicator 246 configured to change appearance in response to a an input provided to the faucet system 100 (including the fixture 202), such as an input received from any of the user interface controller 200, the handle control 116, or the module interface 258. The fixture indicator 246 may be a light (e.g., LED) that is configured to change modes (e.g., brightness, color, solid, blinking, on/off, etc.) depending on the status of one of the enhancement module 222 or the water treatment system 104. While the fixture indicator 246 is shown as a narrow light, the fixture indicator 246 may take multiple forms, including a light ring that wraps circumferentially about the base 210.

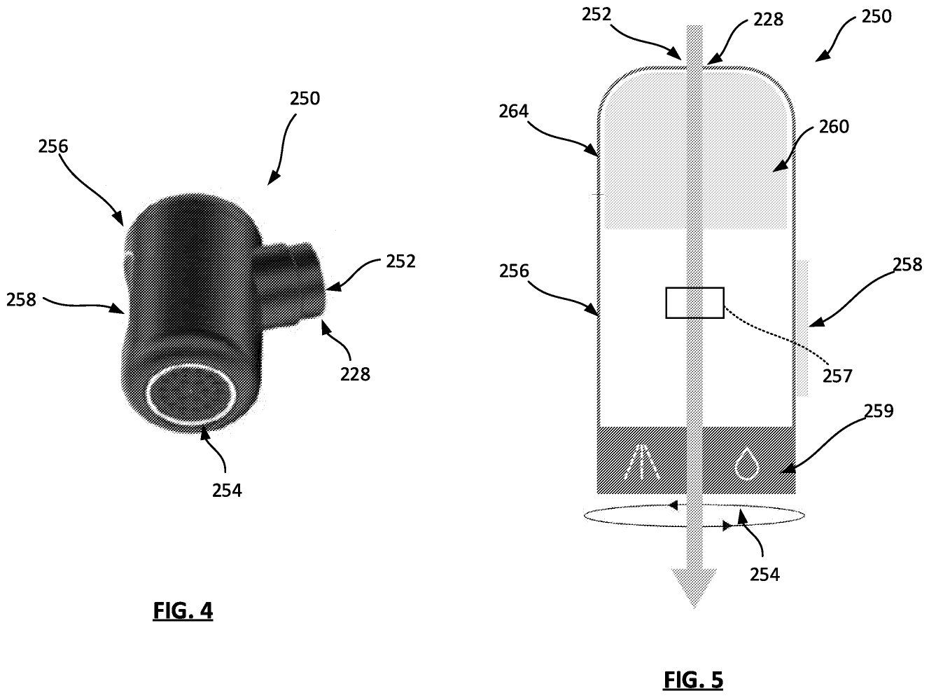

Referring now to FIGS. 4 and 5, the enhancement module 222 is shown as an ozone module 250 (e.g., ozone generating module, ozonator, ozinator, etc.). The ozone module 250 is configured to receive a flow of water from the fixture 202, selectively provide a treatment to the flow of water, and discharge the treated water. In some embodiments, the ozone module 250 receives a treated flow of water and then provides a second treatment to the treated flow of water. For example, the ozone module 250 may receive a flow of water having a pH above 7 (e.g., 8) and then ozonate the treated water to provide an ozonated, high-pH flow of water. In some embodiments, the ozone module 250 is an electrolytic ozonation device configured to pass an electrical current through water to break the oxygen molecules into oxygen atoms and create ozonated water. In some embodiments, the ozone module 250 is a venturi injector ozonation device configured to dissolve ozone gas into a flow of water using a venturi nozzle. In some embodiments, the ozone module 250 is an ultraviolet light ozone generator that uses ultraviolet light to break oxygen molecules into oxygen atoms, which combine with oxygen molecules to create ozonated water.

The ozone module 250 includes an inlet 252 and an outlet 254. The inlet 252 includes the module fitting 228 and is configured for coupling with the handle portion 220 of the fixture 202. As outline above, the module fitting 228 is configured to receive power and, in some embodiments, data, from the faucet system 100 (e.g., the handle fitting 226) when coupled to the fixture 202. Referring specifically to FIG. 4, the ozone module 250 incudes a substantially cylindrical body 256 having the outlet 254 positioned at one end of the cylindrical body 256. The inlet 252 may be positioned in a side of the cylindrical body 256 such that the flow of water enters the ozone module 250 at an angle with respect to an axis of the cylindrical body 256. In other words, the inlet 252 and the outlet 254 are not parallel or collinear to one another (e.g., the inlet 252 is not opposite the outlet 254). In some embodiments, as shown in FIG. 5, the inlet 252 and the outlet 254 are collinear. In other words, the flow of water enters the ozone module 250 through an end of the cylindrical body 256 opposite to the outlet 254 (e.g., the inlet 252 is opposite to the outlet 254).

The ozone module 250 further includes a module interface 258 that is operable by a user. The module interface 258 maybe positioned at an end of the cylindrical body 256 or may be, as shown in FIGS. 4 and 5, positioned on a side of the cylindrical body 256. Referring specifically to FIG. 4, the module interface 258 is positioned 180 rotational degrees from the inlet 252. The module interface 258 is configured to adjust operation of the faucet system 100. In some embodiments, an interaction with the module interface 258 causes a spray mode of the ozone module 250 to change. For example, the ozone module 250 may default to a laminar or aerated flow (e.g., stream), and an interaction with the module interface 258 may cause the spray mode to change to a different spray mode, such as “shower.” The module interface 258 may be mechanical such that power is not required to change the spray mode. In some embodiments, such as when the ozone module 250 includes a closed-loop controller that is communicably isolated from the faucet system 100, an interaction with the module interface 258 may activate and deactivate the ozone module 250 such that a treatment is selectively provided to the flow of water flowing through the ozone module 250. In some embodiments, a user interaction with the module interface 258 changes a concentration of the ozonated water generated by the ozone module 250. For example, the module interface 258 may include up and down buttons, denoted by arrows or “−” and “+” signs, that allow the user to adjust the ozone concentration of the flow of water discharged from the ozone module 250. In some embodiments, the module interface 258 adjusts the input voltage provided to an internal treatment device 260 (FIG. 5) of the ozone module 250. In some embodiments, the ozone module 250 includes a module flow sensor 257 that measures an ozone concentration of the water being discharged from the ozone module 250. Accordingly, the user may select a specific concentration using the module interface 258 (e.g., 2 PPM), and the close-loop controller of the ozone module 250 may automatically adjust the input voltage to achieve the desired concentration, such as by a feedback loop controller. In some embodiments, an interaction with the module interface 258 activates and deactivates the treatment device 260, which may occur whether or not water is flowing through the ozone module 250.

In some embodiments, the ozone module 250 communicates with the system controller 230 of the faucet system 100 via the fittings 227. For example, when the ozone module 250 is coupled to the handle portion 220, the system controller 230 may detect that the ozone module 250 is coupled to the faucet system 100 and selectively control behavior of the ozone module 250. For example, the system controller 230 may set a temperature limit (e.g., maximum) or a flow rate limit on the faucet system 100 to prevent damage to the ozone module 250. In some embodiments, the system controller 230 sets a temperature minimum or a flow rate minimum, below which the system controller 230 inactivates operation of the treatment device 260. For example, if the module flow sensor 257 detects that a flow rate flowing through the ozone module 250 is below a threshold flow rate, the system controller 230 may deactivate the treatment device 260 and/or disable the module interface 258 to prevent actuation of the treatment device 260. In some embodiments, the system controller 230 prevents operation of the ozone module 250 if the faucet system 100 is off and no water is being provided to the ozone module 250. This may be desirable to prevent modules from “running dry,” as some modules may become damaged or cause injury when operated without a flow of water (e.g., a steam generator that is left on when no water is running). The system controller 230 may receive a signal from the ozone module 250 and configure to ozone generator to turn on when a start command is received, such as from the handle control 116. For example, the module interface 258 may include an “activate” switch that sends a signal to the system controller 230 to activate the treatment device 260 in response to receiving a start flow command (e.g., in response to detecting that the handle control 116 is moved out of the off position).

When the module interface 258 is set to “activate,” the treatment device 260 remains off until a “start flow” signal is received by the system controller 230, such as from the handle control 116.

When the system controller 230 receives a “start flow” command, such as from a user operating the handle control 116 and the mixing valve 118 to start a flow of water through the faucet system 100, the system controller 230 activates the treatment device 260 to provide a treatment to the flow of water. In some embodiments, the system controller 230 activates the treatment device on a time delay to prevent the treatment device 260 from running dry.

In some embodiments, the system controller 230 deactivates the module interface 258 in response to receiving the start command such that the treatment device 260 is not selectively operable while water is being discharged from the ozone module 250. To activate or deactivate the treatment device 260, the user would have to turn off the water, such as with the handle control 116 and the mixing valve 118, and then engage the module interface 258. This may prevent accidental activation or deactivation of the treatment device 260 while in use. This may be desirable for embodiments where the ozone module 250 includes the brush 122 and the user is maneuvering the ozone module 250 to scrub something in the sink.

In some embodiments, the system controller 230 is configured to detect both approved and unapproved enhancement modules 222. For example, if a user attempts to connect an unapproved enhancement module 222 to the handle portion 220, the system controller 230 detects that the enhancement module 222 is unapproved and does not provide power and/or data to the unapproved enhancement module. Such an embodiment may be desirable in cases where unapproved enhancement modules have compatibility issues with the system controller 230 or the handle fitting 226. For example, an improperly calibrated voltage regulator or poorly insulated electronics contained in an unapproved enhancement module may cause shock and/or burns to the user.

Referring specifically to FIG. 5, a cross-sectional view of the ozone module 250 is shown, according to an example embodiment. The treatment device 260 is positioned proximate to the end of the cylindrical body 256 opposite to the outlet 254. The treatment device 260 is positioned upstream of the outlet 254 and is configured to receive a flow of water from the fixture 202. The ozone module 250 further includes a spray dial 259 positioned proximate to the outlet 254. The spray dial 259 is pivotally (e.g., rotatably) coupled to the cylindrical body 256 and is configured to adjust a spray mode of the ozone module 250. Rotation of the spray dial 259 relative to the cylindrical body 256 causes the spray mode of the ozone module 250 to change, such as from a stream spray to a shower spray.

In some embodiments, the cylindrical body 256 includes an air input 264. The air input 264 extends through the cylindrical body 256 and into the treatment device 260. In embodiments where ozone module 250 is a venturi ozonator, the air input 264 receives a flow of air, transforms the air into ozone gas, and dissolves the ozone gas into the flow of water to create an ozonated flow of water.

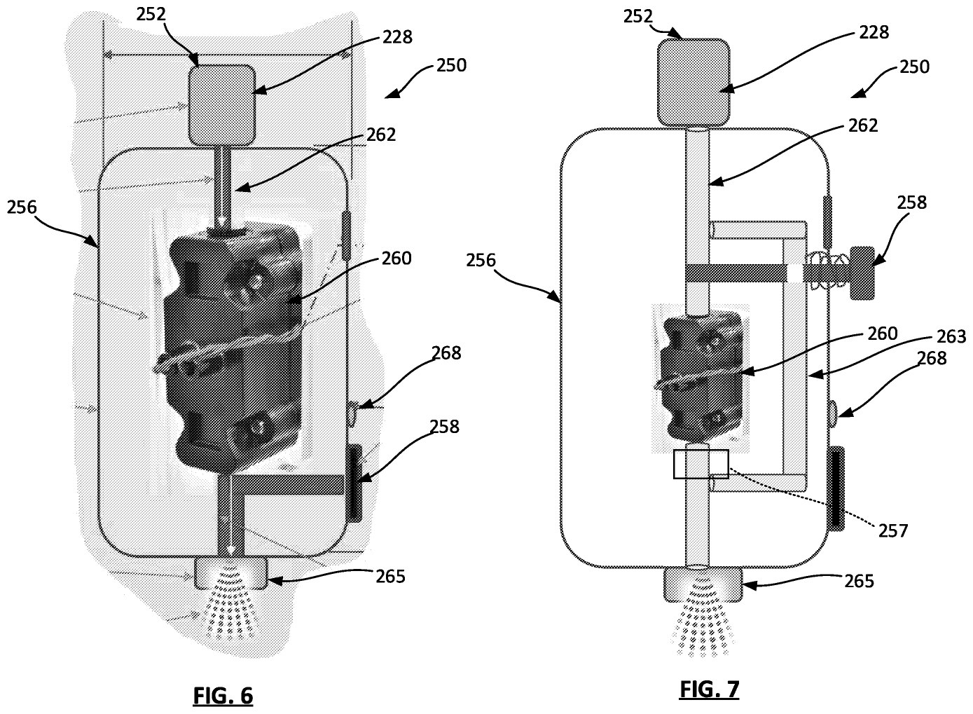

Referring now to FIG. 6, a cross-sectional view of the ozone module 250 is shown according to an example embodiment. The ozone module 250 includes the module fitting 228 configured for coupling to a fixture, such as the fixture 102 and the fixture 202. The module fitting 228 receives a flow of water from the fixture and provides the flow of water to the treatment device 260 via a feed water conduit 262. The treatment device 260 is operable in an “active” state and an “inactive” state. Within the active state, the treatment device 260 may be operated at different intensities such that the flow of water includes more or less of the treatment. For example, in embodiments where the treatment device 260 is an ozone generator, the ozone generator may be operated to provide various concentrations of ozone (e.g., 2 PPM, 4 PPM, 8 PPM, etc.) to the flow of water. When the treatment device 260 is in the inactive state, a flow of water may flow through the treatment device 260 without being treated. As shown in FIG. 6, the only flow path from the module fitting 228 to the outlet 254 is through the treatment device 260. Accordingly, the treatment device 260 is structured to allow an uninterrupted flow (or nearly uninterrupted flow) of water therethrough while the treatment device 260 is in the inactive state.

The treatment device 260 is further configured to receive power via the module fitting 228. The treatment device 260 may be a low-watt ozonating device requiring a power input of between 3-4.5 watts. In some embodiments, the ozone module 250 includes a rechargeable power supply, such as a battery, and the ozone module 250 is configured for docking in a charging station when disconnected from the handle portion 220.

In some embodiments, the ozone module 250 further includes a spray nozzle 265 coupled to the outlet 254 and configured to provide a mist spray mode. In some embodiments, the module interface 258 is a toggle switch that controls a spray output of the ozone module 250, but does not affect operation of the treatment device 260. For example, the user interface controller 200, in embodiments where the user interface controller 200 is physically separate from the ozone module 250, may configured operation of the treatment device 260 regardless of a user engagement with the module interface 258. This may be desirable to prevent accidental activation and deactivation of the treatment device 260 when the first spray head 114 is being maneuvered by a user, such as for scrubbing.

The ozone module 250 further includes a module indicator 268. As shown in FIG. 6, the module indicator 268 is a light (e.g., LED) that may change modes (e.g., brightness, color, solid, blinking, on/off, etc.) depending on the status of the treatment device 260. The module indicator 268 may indicate to the user the operating status of the treatment device 260. For example, the module indicator 268 may shine solid green if the treatment device 260 is configured to be inactive when (e.g., while) a flow of water is flowing through the fixture 202. The module indicator 268 may blink red when the treatment device 260 is configured to be active while water is flowing through the fixture 202.

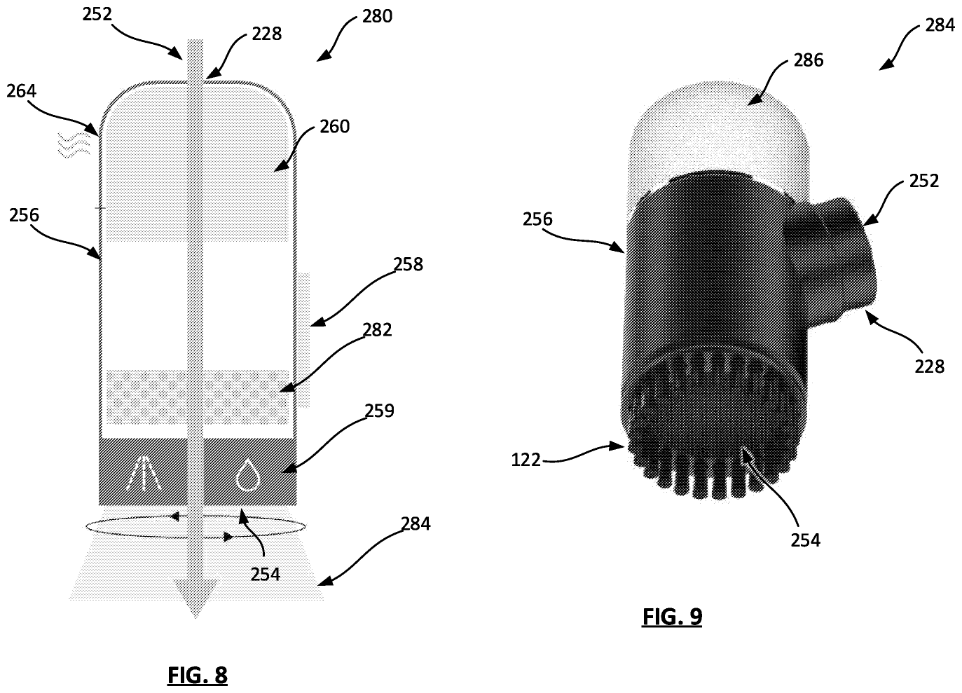

Referring now to FIG. 8, a cross-sectional view of the ozone module 250 is shown according to another example embodiment. The ozone module 250 includes the module fitting 228 configured for coupling to a fixture, such as the fixture 102 and the fixture 202. The module fitting 228 receives a flow of water and provides the flow of water to the treatment device 260 via the feed water conduit 262. The ozone module 250 of FIG. 7 is similar to the ozone module 250 of FIG. 6. A difference between the ozone module 250 of FIG. 6 and the ozone module of FIG. 7 is that the ozone module 250 of FIG. 7 includes a bypass conduit 263 that provides a flow path from the inlet 252 to the outlet 254 that does not go through the treatment device 260. The module interface 258 may be a mechanical valve that mechanically opens and closes the bypass conduit 263 while simultaneously and respectively closing and opening the feed water conduit to the treatment device 260. As shown in FIG. 7, the module interface 258 is in a default position (e.g., unpressed, not pressed, etc.). When the module interface 258 is in the default position, the flow of water is prevented from entering the treatment device 260 and allowed to flow through the bypass conduit 263 such that the flow of water that exits the ozone module 250 is not treated by the treatment device 260. When the module interface 258 is depressed (e.g., pressed, activated, engaged with, etc.), the module interface 258 prevents the flow of water from flowing through bypass conduit 263 and allows the flow of water to flow through the feed water conduit 262 and through the treatment device 260. In some embodiments, the module interface 258 may be reconfigured such that in the default position water flows through the treatment device 260, and when the module interface 258 is depressed, water is prevented from flowing through the treatment device 260 and is biased (e.g., redirected) through the bypass conduit 263. In some embodiments, the module interface 258 is configured such that the flow path is a binary choice. In other words, either all of the flow of water is directed through the feed water conduit 262 to the treatment device 260 or all of the flow of water is directed through the bypass conduit 263. In some embodiments, the module interface 258 is structured to allow the user to flow a portion of the flow of water through both the treatment device 260 and through the bypass conduit 263 at the same time.

In some embodiments, the treatment device 260 is automatically activated in response to moving the handle control 116 out of the off position such that any water that flows through the treatment device 260 will be treated. In some embodiments, the treatment device 260 includes the module flow sensor 257 that detects when a flow of water is flowing through the treatment device 260. The module flow sensor 257 may detect a flow rate and/or a temperature of the water that flows through the treatment device 260. In response to the module flow sensor 257 detecting that a threshold amount of water is flowing through the treatment device 260, the treatment device 260 may automatically activate and provide a treatment to the flow of water flowing through the treatment device 260. The treatment device 260 is further configured to automatically deactivate (e.g., turn off) in response to the module flow sensor 257 detecting that the flow of water through the treatment device has fallen below the threshold flow rate and/or the threshold temperature. For example, if the treatment device 260 is an ozone generator, the ozone generator may require a certain flow rate to prevent damage to the electrodes and the other internal components. In some embodiments, such as where the module interface 258 is entirely mechanical, the module interface 258 does not directly control the activation and deactivation of the treatment device 260. For example, even if the module interface 258 is activated such that 100% of the flow of water flows through the treatment device 260, the treatment device 260 may not activate because the flow of water flowing into the ozone module 250, controlled by, for example, the handle control 116 or the user interface controller 200, may not meet the minimum required flow rate threshold and/or the minimum required temperature threshold to activate the treatment device 260 via the module flow sensor 257.

Referring now to FIG. 8, the enhancement module 222 is shown as a bubble module (e.g., bubble generator, microbubble generator, nanobubble generator, etc.) 280. The bubble module 280 is configured to receive a flow of water from a fixture, create (e.g., generate) bubbles in the flow of water, and discharge the treated water from the outlet 254. The bubble module 280 is similar to the ozone module 250. Accordingly, like numbering is used to denote like parts between the ozone module 250 and the bubble module 280. A difference between the bubble module 280 and the ozone module 250 is that the bubble module 280 includes a second treatment device, shown as a bubble device 282, positioned downstream from the treatment device 260 (e.g., first treatment device) and positioned upstream of the outlet 254. In some embodiments, the bubble device 282 is positioned upstream from the treatment device 260. The bubble device 282 is configured to create bubbles in the flow of water, whether treated or untreated. In embodiments where the bubble module 280 includes both the treatment device 260 and bubble device 282, the bubble module 280 is configure to provide an ozonated flow of water having bubbles. The module interface 258 may include additional controls, such as extra buttons, sliders, toggles, and the like such that both the treatment device 260 and the bubble device 282 are configurable (e.g., controllable) via the module interface 258. As outlined above with respect to the ozone module 250, the bubble device 282 is controllable in the same ways (e.g., closed-loop control, controllable by the faucet system 100, controllable using an external remote, controllable via mobile device (e.g., mobile phone), etc.).

The bubble module 280 further includes the module indicator 268. As shown in FIG. 6, the module indicator 268 is a light (e.g., LED) that may change modes (e.g., brightness, color, solid, blinking, on/off, etc.) depending on the status of the bubble module 280. As will be appreciated, the module indicator 268 may be provided with any of the enhancement modules 222 (e.g., the ozone module 250, the bubble module 280, the concentrate module 284, etc.) disclosed in the present application. The module indicator 268 is coupled to the bubble module 280 proximate to the outlet 254 and shines away from the end of the cylindrical body 256. For example, if a flow of water is exiting the bubble module 280, the module indicator 268 may shine a light into and through the flow of water. The module indicator 268 may indicate to the user the operating status of the bubble module 280. Since microbubbles and nanobubbles reflect light, the module indicator 268 may be configured to turn on when the bubble module 280 is configured to discharge a bubble-treated flow of water, but the module indicator 268 may be off otherwise. Thus, the user may be able to see the bubbles in the flow of water, which may be aesthetically pleasing.

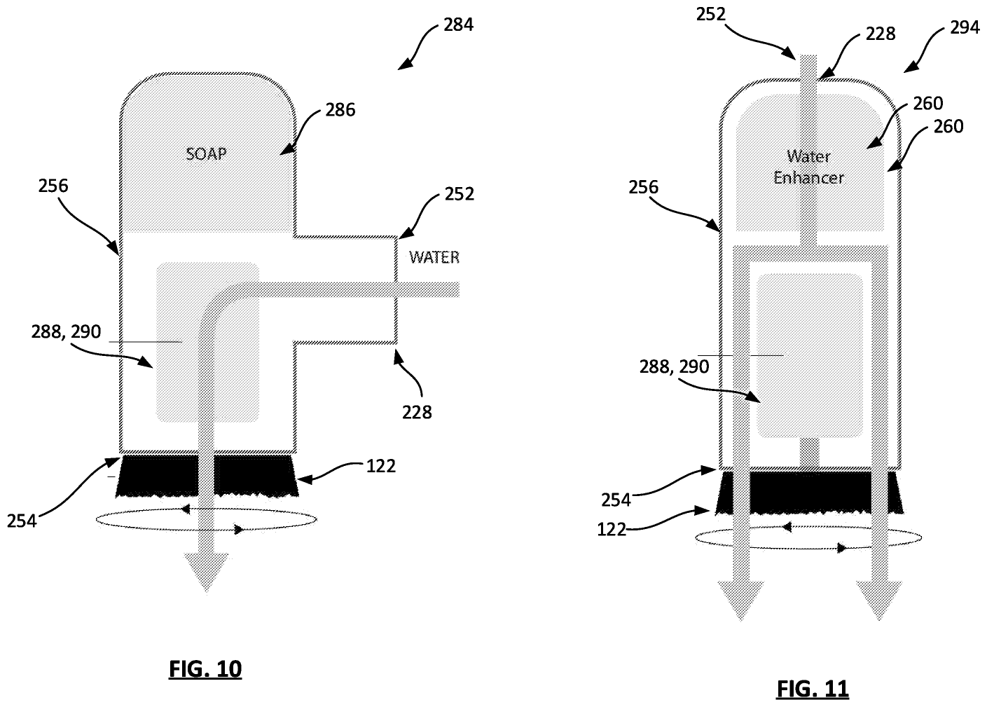

Referring now to FIGS. 9 and 10, the enhancement module 222 is shown as a concentrate module 284. The concentrate module 284 is similar to the ozone module 250. Accordingly, like numbering is used to denote like parts between the ozone module 250 and the concentrate module 284. A difference between the ozone module 250 and the concentrate module 284 is that the concentrate module 284 includes a module reservoir 286 for holding a volume of concentrate (e.g., liquid concentrate, powdered concentrate, etc.). The module reservoir 286 is coupled to (e.g., selectively coupled to, removably coupled to) the cylindrical body 256. The module reservoir 286 is in fluid communication with the inlet 252 and the outlet 254 such that the concentrate module 284 may add a concentrate to the flow of water downstream of the inlet 252 and upstream of the outlet 254. In some embodiments, the concentrate module 284 is configured to provide the concentrate from the module reservoir 286 into the flow of water discharged from the outlet 254 such that the concentrate is not combined with the flow of water within the concentrate module 284. The concentrate may be a soap, cleaning concentrate (e.g., bleach, detergent, pine sol, etc.), laundry detergent, and the like. In some embodiments, the module reservoir 286 is removably coupled to the cylindrical body 256 such that the module reservoir 286 may be removed, cleaned, refilled, and replaced. In some embodiments, the module reservoir 286 is integrally formed with the cylindrical body 256 and refillable via a check valve or similar fitting. In some embodiments, the module reservoir 286 is self-cleaning. For example, a control on the module interface 258 may allow a user to divert the flow of water provided by the fixture directly into the module reservoir 286 for the purposes of flushing out the remaining concentrate. In some embodiments, the module reservoir 286 is compliant such that pressing on the module reservoir 286 discharges the concentrate into the flow of water flowing through the concentrate module 284. In some embodiments, a portion of the module reservoir 286 is compliant (e.g., the module reservoir 286 includes a push bladder button) such that a user interaction with the compliant portion of the module reservoir 286 discharges a portion of the concentrate into the flow of water.

The cylindrical body 256 further includes the module interface 258. A concentration may be controllable via the module interface 258. For example, the module interface 258 may include up and down buttons and an LCD screen. A user interaction with the up button may increase an output concentration of the concentrate into the flow of water while outputting the concentration to the LCD screen so that the user can visually see the concentration output from the concentrate module 284. For example, highly concentrated cleaners, such as decalcifiers and delimers, may be discharged at a small ratio, such as a ratio of 1:60 or 1:30. When the concentrate module 284 is configured to discharge a flow of water having 1:60 concentrate ratio, a “1:60” may be displayed on the LCD screen. In embodiments where the concentrate is less potent, such as dish detergent, the up button may be pushed and the concentrate module 284 may discharge a larger concentration of ratio, such as 1:15 or 1:8. When the concentrate module 284 is configured to discharge a flow of water having 1:8 concentrate ratio, a “1:8” may be displayed on the LCD screen.

Referring specifically to FIG. 9, the inlet 252 of the concentrate module 284 extends from the cylindrical body 256 at an angle that is neither parallel nor perpendicular to the outlet 254. As shown in FIG. 10, the inlet 252 extends from the cylindrical body 256 perpendicularly relative to a central axis of the cylindrical body 256.

Referring specifically to FIG. 10, a cross-sectional view of the concentrate module 284 is shown. The concentrate module 284 further includes a scrubbing device 288 comprising an actuator 290 positioned within the cylindrical body 256 and the brush 122 coupled to the cylindrical body 256 proximate to the outlet 254. The actuator 290 may be a low-watt actuator configured to receive power via the fittings 227. In some embodiments, the concentrate module 284 includes a rechargeable power supply, such as a rechargeable battery. When the concentrate module 284 is removed from the handle portion 220, the concentrate module 284 may be charged on a charging dock. The actuator 290 is operably coupled to the brush 122, the brush 122 being rotatably (e.g., pivotally) coupled to the cylindrical body 256. The brush 122 is operated (e.g., rotated, spun, oscillated, etc.) by the actuator 290 in response to a user interaction with a control of the faucet system 100. In some embodiments, the scrubbing device 288 is actuated in response to a user interaction with the module interface 258. In some embodiments, the scrubbing device 288 is actuated in response to a user input to the user interface controller 200.

In some embodiments, such as when the fittings 227 include both power and data, the scrubbing device 288 may be communicatively coupled to the system controller 230. The system controller 230 may selectively allow operation of the scrubbing device 288 in response to detecting a docking position of the first spray head 214. For example, if the first spray head 214 is in a docked position, the system controller 230 may prevent actuation of the scrubbing device 288 by the module interface 258 such that the scrubbing device 288 does not oscillate and begin to move while the first spray head 214 is docked.

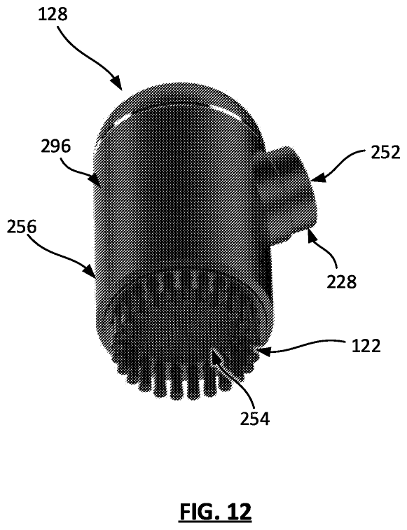

Referring now to FIG. 11, the enhancement module 222 is shown as a scrubbing module 294. The scrubbing module 294 is similar to the ozone module 250. Accordingly, like numbering is used to denote like parts between the scrubbing module 294 and the ozone module 250. A difference between the ozone module 250 and the scrubbing module 294 is that the scrubbing module 294 includes the scrubbing device 288. In some embodiments, it may be desirable to scrub a surface while dispensing a treated flow of water. For example, the treatment device 260 may be configured to create bubbles in the flow of water to aid with the scrubbing of the scrubbing device 288. In some embodiments, the brush 122 is removable and replaceable. For example, the brush 122 may become damaged or worn from scrubbing rough surfaces, including cast iron, stove and grill grates, oven racks, and the like. A user may have multiple brushes, each having different brush stiffness and length. As can be appreciated, many attachments may be operably coupled to the actuator 290 for the purposes of cleaning (e.g., sponge, scrub bad, steel wool, wire brush, etc.).

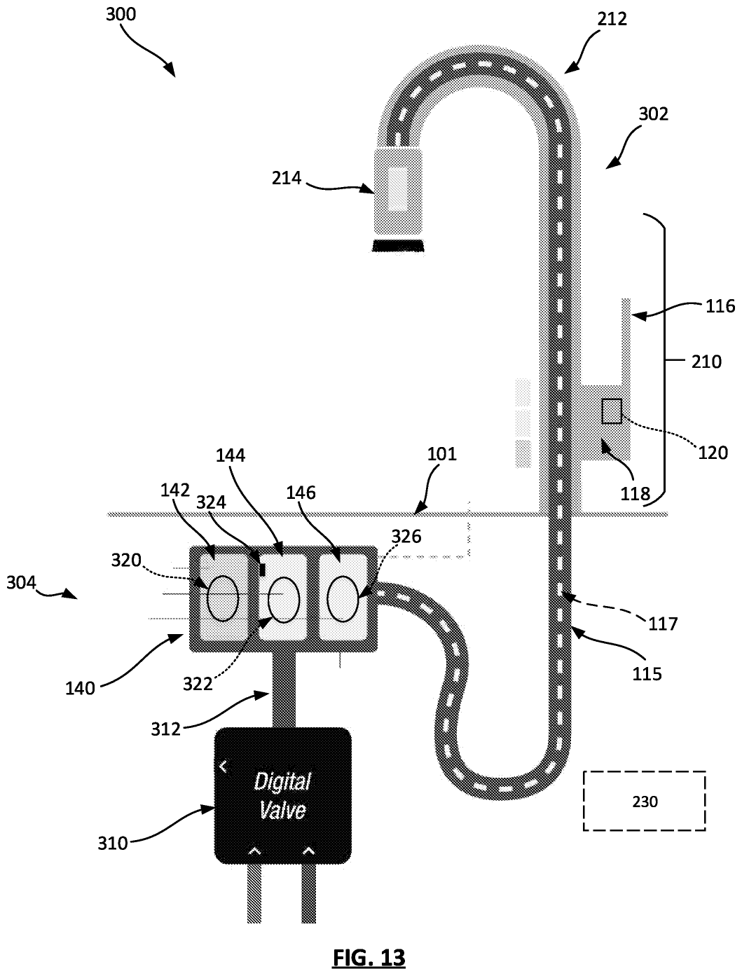

Referring now to FIG. 12, the enhancement module 222 is shown as the steam module 128. The steam module 128 is similar to the scrubbing module 294. Accordingly, like numbering is used to denote like parts between the steam module 128 and the scrubbing module 294. A difference between the scrubbing module 294 and the steam module 128 is that the treatment device 260 of the steam module 128 is a steam device. The steam device is configured to receive a flow of water and output steam via the outlet 254. The steam module 128 may include a heat insulating jacket 296, such as one made of silicone, that surrounds the cylindrical body 256 and remains cool to the touch while the steam device is active. The steam device may be communicatively coupled to the system controller 230 via the fittings 227 when the fittings 227 include both power and data transmission. The system controller 230 is configured to selectively activate or deactivate the steam device in response to a user interaction with the faucet system 100 (e.g., the user interface controller 200, the module interface 258). In some embodiments, the system controller 230 prevents activation of the steam device when the first spray head 214 is in a docked position. In some embodiments, re-docking the first spray head 214 to the neck 112 of the fixture 202 automatically deactivates the steam device. In some embodiments, the system controller 230 is configured to activate the steam device only when (e.g., after) certain conditions of the faucet system 100 are met. For example, in order to activate the steam device with the module interface 258, the flow of water such reach a certain temperature (e.g., 100° F.). When the water reaches the predetermined temperature, the system controller 230 activates the module interface 258 and allows the user to activate the steam device after removing the first spray head 214 from the neck 112. In some embodiments, the system controller 230 automatically activates the steam device in response to certain conditions being met. For example, when the flow of water through the fixture 102 reaches a predetermined temperature, the system controller 230 may activate the steam device and turn on the module indicator 268 to signal to the user that the steam module 128 is ready for use. The scrubbing device 288 coupled to the steam module 128 may include a heat resistant brush 122 having hard bristles.

Referring now to FIG. 13, a faucet system 300 is shown, according to an example embodiment. The faucet system 300 is configured to receive a flow of water, selectively provide a treatment to the flow of water, and discharge the flow of water, whether treated or untreated. The faucet system 300 is similar to the faucet system 100. Accordingly, like numbering is used to denote like parts between the faucet system 100 and the faucet system 300. A difference between the faucet system 100 and the faucet system 300 is that that faucet system 300 does not include the second spray head 124.

The faucet system 300 includes a fixture 302 and a water treatment system 304. The fixture 302 includes the base 210, the neck 212, and the first spray head 214. Positioned below the fixture 302 is the reservoir module 140 including the first reservoir 142, the second reservoir 144, and a third reservoir 146. Fluidly coupled to the reservoir module 140, and positioned upstream from the reservoir module 140, is a valve assembly 310. The valve assembly 310 is configured to receive a hot and cold supply of water, such as from municipal supply lines, and provide a mixed flow of water to the reservoir module 140 via a supply conduit 312. In some embodiments, the valve assembly 310 is combined with the reservoir module 140 such that the supply conduit 312 is integral within the reservoir module 140. In some embodiments, the hot and cold supply water flows are combined downstream from the reservoir module 140. For example, a cold flow of water may be in fluid communication with the reservoir module 140 such that the first reservoir 142, the second reservoir 144, and the third reservoir 146 contain cold water (e.g., 80° F. or less), and the reservoir module 140 provides a treatment to the cold water. In such an embodiment, the valve assembly 310 is positioned downstream from the reservoir module 140 such that the valve assembly 310 receives a hot flow of water (e.g., 120° F.) from a hot supply line and a cold supply of water from the reservoir module 140. The valve assembly 310 is configured to combine the flows of water to generate a flow of water having the desired temperature, and the valve assembly 310 is configured to provide the flow of water to the fixture 302. The valve assembly 310 may include a pass-through conduit that bypasses the first reservoir 142, the second reservoir 144, and the third reservoir 146 such that an untreated cold flow of water is mixed by the valve assembly 310 and provided to the fixture 302. In some embodiments, the hot supply of water is provided to the reservoir module 140 and the cold supply of water is provided directly to the valve assembly 310 downstream from the reservoir module 140.

The first reservoir 142 is configured to maintain a volume of water and selectively treat the volume of water. In some embodiments, the first reservoir 142 is an ozone reservoir configured to create and maintain a first volume of ozonated water. The first reservoir 142 includes an ozone-generating device 320 that may ozonate the first volume of water through electrolytic ozonation, dissolving ozone gas in the volume of water (such as by venturi injection or other known methods of dissolving), ultraviolet ozonation of the volume of water, any combination of the aforementioned ozonation methods, or any other known method for generating ozonated water in a volume of water. The ozone reservoir may be communicatively coupled to the system controller 230 such that a user interface controller (e.g., the user interface controller 200) controls the operation of first reservoir 142. For example, the user interface controller 200 may allow the user to adjust the ozone concentration of the volume of water in the first reservoir 142. In some embodiments, the first reservoir 142 automatically maintains a default amount of ozonated water at a default concentration. In response to a request for an ozonated flow of water, such as from the user interface controller 200, the valve assembly 310 may selectively combine the ozonated water from the first reservoir 142 with the untreated water from the supply line to provide an ozonated flow of water having the desired concentration.

The second reservoir 144 is configured to maintain a second volume of water fluidly isolated from the first volume of water maintained by the first reservoir 142. The second reservoir 144 may be a bubble reservoir that is configured to selectively create bubbles in the second volume of water. The second reservoir 144 includes a bubble generator 322 communicatively coupled to the system controller 230 such that a user interaction with the user interface controller controls operation of the bubble generator 322. For example, a user may select a type of bubble (nanobubble or microbubble) for the bubble generator 322 to generate in the second volume of water. The second reservoir 144 further includes a fill sensor 324 configured to measure the second volume of the water within the second reservoir 144. The fill sensor 324 may send a signal to the system controller 230 to operate the valve assembly 310 to divert a flow of water into the second reservoir 144 automatically without an additional input provided by the user. For example, the fill sensor 324 may detect that the second volume of water has reached a minimum level and initialize a filling of the second reservoir 144. The fill sensor 324 may then detect that the second reservoir 144 is filled to a maximum level to stop a filling event of the second reservoir 144.

The third reservoir 146 is configured to maintain a third volume of water, the third reservoir 146 fluidly isolated from the first reservoir 142 and the second reservoir 144. The third reservoir 146 may be a steam reservoir configured to generate steam and provide a flow of steam to the first spray head 214. The third reservoir 146 includes a steam generator 326 that is configured to transform the third volume of water into steam. The steam generator 326 is operably coupled to the system controller 230 such that a user interaction, such as with the user interface controller 200, controls operation of the steam generator 326. For example, the steam generator 326 may default to a stand-by mode, where the third volume of water to heated to a high temperature, but is not heated enough to form steam. In response to a start command received by system controller 230, such as from the handle control 116, the system controller 230 may operate the steam generator 326 to generate steam from the third volume of water and provide the steam to the first spray head 214. The first fluid conduit 115 may be a heat-resistant and insulating conduit such that the steam generated by the steam generator 326 is able to reach the first spray head 214 without significant heat losses. In some embodiments, the first fluid conduit 115 includes an inline heater that maintains a higher temperature of the first fluid conduit 115 when the steam generator 326 is activated, but turns off the in-line heater otherwise. In some embodiments, the first spray head 214 is an enhancement module 222 that is specifically designed to handle the high temperatures of steam provided from the third reservoir 146. In such embodiments, the system controller 230 may receive a signal from the enhancement module 222 indicating whether or not the enhancement module 222 is configured to receive high-temperature steam. For example, if the enhancement module 222 is not configured to handle steam, the system controller 230 may prevent activation of the steam generator 326 to prevent damage to the enhancement module 222 and to prevent injury to the user. If the enhancement module 222 is configured to handle steam (e.g., the steam module 128), the system controller 230 may receive a signal, such as via the fittings 227, that the steam generator 326 may be activated in response to user interaction with the faucet system 300.

Referring still to FIG. 13, the first spray head 214 may be an enhancement module 222, such as the scrubbing module 294 (FIG. 9). The scrubbing module 294 may be communicatively coupled to the system controller 230 and the reservoir module 140 via the first electrical conduit 117 that extends along the length of the first fluid conduit 115. The first electrical conduit 117 may provide both power and data to the first spray head 214.

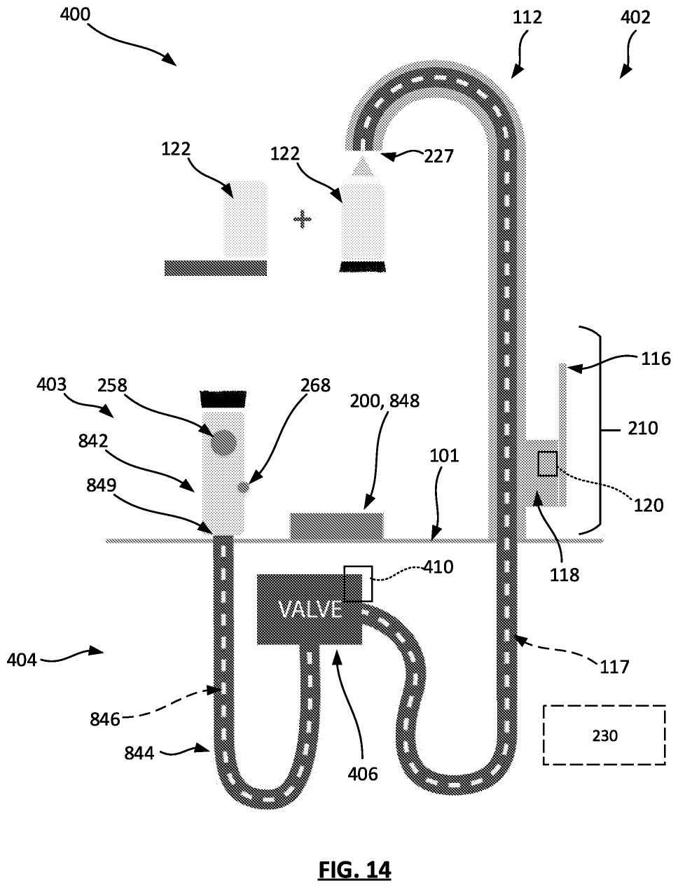

Referring now to FIG. 14, a faucet system 400 is shown, according to an example embodiment. The faucet system 400 includes a first fixture 402, a second fixture 403, and a water treatment system 404. The water treatment system 404 includes a valve assembly 406 positioned below the surface 101 on which the first fixture 402 and the second fixture 403 are mounted. The first fixture 402 is similar to the fixture 102. Accordingly, like numbering is used to denote like parts between the fixture 102 and the first fixture 402. A difference between the first fixture 402 and the fixture 102 is that the first fixture 402 does not include the second spray head 124. Instead, the faucet system 400 includes the second fixture 403 retractable into the surface 101. The second fixture 403 may be fluidly isolated from the first fixture 402 such that two different flows of water may be discharged from the first fixture 402 and the second fixture 403 at the same time. The first fixture 402 and the second fixture 403 are fluidly coupled to the valve assembly 406 and are configured to receive a flow of water from the valve assembly 406.

The water treatment system 404 is configured to receive a flow of water, selectively provide a treatment to the flow of water, and provide the flow of water to one of or both of the first fixture 402 and the second fixture 403. For example, the water treatment system 404 may discharge ozonated water, filtered water, water having a concentrate, water having bubbles, electrolyzed water, pH-adjusted water, and the like. In some embodiments, the valve assembly 406 includes a water treatment device 410 configured to selectively provide a treatment to a flow of water provided to the first fixture 402. In some embodiments, the valve assembly 406 is substantially similar to the reservoir module 140. The valve assembly 406 is further configured to provide multiple flow of water such that a first treated flow of water is provided by the valve assembly 406 to the first fixture 402, and a second treated flow of water is provided by the valve assembly 406 to the second fixture 403, where the treatment provided to the first treated flow of water if different from the treatment provided to the second flow of water. For example, the valve assembly 406 may provide a flow of nanobubble water to the first fixture 402 and provide a flow of steam to the second fixture 403.

The second fixture 403 includes a second spray head 842 and a second fluid conduit 844 extending between, and fluidly coupling, the second spray head 842 and the valve assembly 406. In some embodiments, an electrical conduit 846 extends along the length of the second fluid conduit 844 and communicatively couples the second spray head 842 to the valve assembly 406. The electrical conduit 846 is configured to carry a data signal, power, or both power and a data signal.

The second spray head 842 may be the enhancement module 222 that is configured to provide a treatment to the fluid received from the valve assembly 406. For example, the valve assembly 406 may not include the treatment device 410 such that the enhancement module 222 is providing the only treatment to the second flow of water. In some embodiments, the treatment device 410 of the valve assembly 406 and the enhancement module 222 are both configured to provide a treatment to the second flow of water. For example, the treatment device 410 may ozonate the second flow of water, and the enhancement module 222 may selectively discharge a concentrate into the second flow of water. The second spray head 842 may be removably coupled to the second fluid conduit 844 such that the second spray head 842 is replaceable with any of the enhancement modules 222 outlines above. The second fluid conduit 844 may include a fitting 849 configured for coupling with the enhancement module 222 and structure to provide power and/or data to the enhancement module 222 via the electrical conduit 846.

The second spray head 842 includes the module interface 258 configured to send a signal to the valve assembly 406. When a user interacts with (e.g., presses, touches, switches, etc.) the module interface 258, a treated fluid is discharged from the second spray head 842. In embodiments, such as when the second spray head 842 is the ozone module 250, the system controller 230 is configured such that an interaction with the module interface 258 both activates (e.g., turns on) the ozonator in the ozone module 250 and starts a flow of water through the water treatment system 404 and to the second fixture 403. In other words, the module interface 258 sends a signal to the valve assembly 406 to provide a flow of water to the second spray head 842 and sends a signal to the ozone module 250 to provide a treatment to the flow of water, both signals being sent at the same time from the same interface (e.g., the module interface 258).

The faucet system 400 further includes the user interface controller 200 configured to provide a signal to the system controller 230 of the faucet system 400. The user interface controller 200 allows a user to control the output of the first spray head 214 and the second spray head 842. For example, where the enhancement module 222 is an ozone module (e.g., the ozone module 250), the user interface controller 200 may set an ozone status, such as “on” or “off,” and an ozone setting, such as a desirable parts per million (PPM) of ozone concentration. When the ozone status is set to “on,” activation of the module interface 258 simultaneously activates the ozone module and starts a flow of water through the faucet system 400. In some embodiments, when the ozone status is set to “on,” engagement with the module interface 258 causes a flow of water to flow through the second fixture 403. After a pre-determined non-zero time delay (e.g., 1 second, 3 seconds, etc.), the system controller 230 activates the ozone module to provide a treatment to the flow of water flowing through the second spray head 842. The aforementioned configuration may be desirable where activating the enhancement module 222 without water could cause damage to the enhancement module 222. In some embodiments, the second spray head 842 includes the module indicator 268 that visually indicates to the user the ozone status. For example, a red light may be displayed to indicate that the second spray head 842 is in a treatment mode such that a start signal (e.g., a signal that starts a flow of water through the valve assembly 406 and to at least one of the first fixture 402 and the second fixture 403, such as from the handle control 116) causes activation of the enhancement module 222 and causes a treated flow of water to exit the second spray head 842. In some embodiments, a green light may be displayed to indicate that the second spray head 842 is in a non-treatment mode, or that the second spray head 842 is discharging an untreated flow of water.

The user interface controller 200 may be further configured to control various other enhancement modules 222. For example, the enhancement module 222 may be a scrubbing module (e.g., the scrubbing module 294) that includes a module reservoir (e.g., the module reservoir 286) and a scrubbing device (e.g., the scrubbing device 288). When the scrubbing module is coupled to the second fluid conduit 844 using the fitting 849, the scrubbing module may send a signal to the system controller 230 that the scrubbing module has been coupled to the second fluid conduit 844. After the controller receives a signal from the scrubbing module that the scrubbing module has been coupled to the second fluid conduit 844, the user interface controller 200 may update to provide controls for operating the scrubbing module. In some embodiments, the user interface controller 200 may include a touch screen (e.g., touch display) that updates in response to detecting which module is coupled to the fitting 849. As outlined above, any of the steam module 128, the ozone module 250, the bubble module 280, the concentrate module 284, and the scrubbing module 294 may send a signal to the user interface controller 200 to update the display 852.

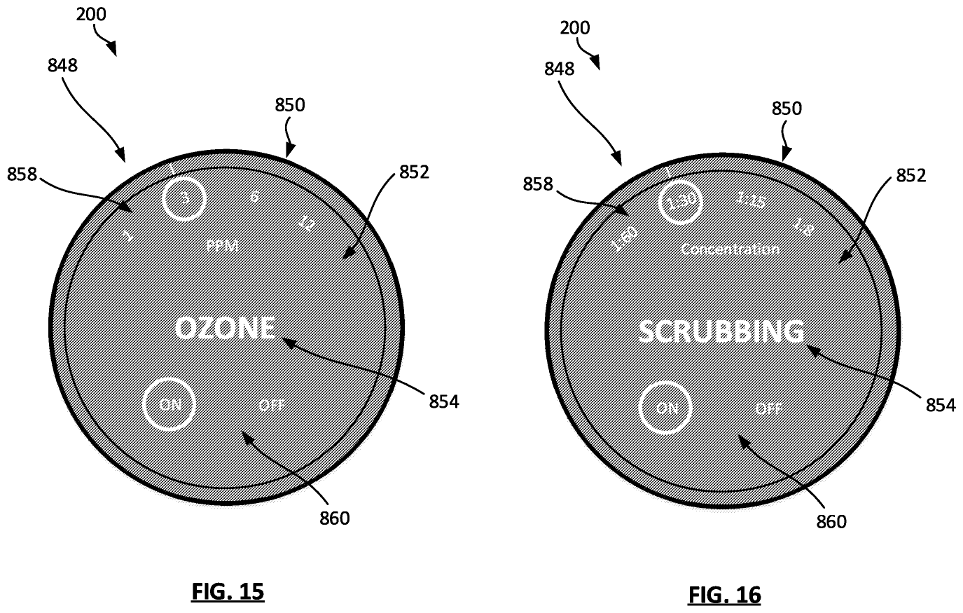

Turning now to FIG. 15, the user interface controller 200 is shown as a control puck 848. The control puck 848 includes a substantially cylindrical body having a movable dial 850 rotatable relative to a display 852. The display 852 may include a system indicator 854 that indicates to the user which module is fluidly coupled to the second fluid conduit 844. As shown in FIG. 15, the system indicator 854 shows “Ozone,” meaning that an ozone module (e.g., the ozone module 250) is fluidly coupled to the second fluid conduit 844. Proximate the circumference of the display 852 of the control puck 848 is an adjustable scale 858 that allows the user to adjust the concentration of the ozonated water discharged from the second spray head 842. Rotation of the dial 850, such as by a user, adjusts the output concentration of the ozone module. Also positioned on the display 852 is a system status control 860 that can be operated to turn on (e.g., allow to first user interface to turn on the ozone module) and turn off (e.g., prevent the first user interface from turning on/off the ozone module) the ozone module. The system status control 860 may be a touch screen that allows the system status to change in response to an interaction by a user.

In some embodiments, the control puck 848 is configured such that pressing down the control puck 848 changes the system status. In some embodiments, the control puck 848 does not include an interactive touch display and is instead a rotary encoder configured to send signals via rotation of the encoder (e.g., such as rotation of the dial 850) and depression of the control puck 848. This may be beneficial to prevent accidental adjustment of the control puck 848 by splashes of water and other undesirable bumping and knocking of a touch screen. In some embodiments, the control puck 848 is positioned on a surface away from the faucet system 400, such as a wall. In some embodiments, the control puck 848 is wireless and is able to be positioned away from the faucet system 400 and repositioned as desired.

Turning now to FIG. 16, the control puck 848 is shown in an embodiment where a scrubbing module (e.g., the scrubbing module 294) is fluidly coupled to the second fluid conduit 844 via the fitting 849. The display 852 of the control puck 848 updates in response to the scrubbing module 294 being coupled to the second fluid conduit 844 via the fitting 849. The scrubbing module 294 sends a signal to the system controller 230 to update the display 852. The display 852 includes the adjustable scale 858, which now displays “Concentration” instead of “PPM,” as described above with respect to the ozone module. For example, if the module reservoir 286 is filled with dish soap and the user is doing light cleaning, the adjustable scale 858 may be adjusted to a ratio of one part soap to 60 parts water (1:60). In some embodiments, the user may fill the module reservoir 286 with a more powerful cleaning solution, such as a degreaser, decalcifier, chlorine bleach, and the like. The adjustable scale 858 may be set to make the discharge from the second spray head 842 more potent, such as 1:8 and higher. The scrubbing module 294 may include the module indicator 268, such as a light, that indicates to the user that the water being discharged from the scrubbing module 294 is non-potable and/or not safe for extended skin contact. In some embodiments, the adjustable scale 858 is configured to adjust a scrubbing speed (e.g., oscillation speed, rotating speed, etc.) of the scrubbing device 288. The adjustable scale 858 may include labels, such as “low,” “medium,” and “high,” each corresponding to a speed of the actuator 290 of the scrubbing device 288. Both the concentration and the speed may be adjusted by the user by turning the dial 850. The user may cycle through the various adjustable features by tapping or double tapping the control puck 848. In some embodiments, rotation of the dial in the clockwise direction adjusts the adjustable scale 858, while rotation of the dial 850 in the counterclockwise direction cycles through the various adjustable features, such as scrubbing speed and concentration.

It should be understood that the various embodiments of the user interface controller 200 may be conceived without straying from the spirit of the disclosure. While the user interface controller 200 is disclosed as being a cylindrical control puck 848, it should be understood that the user interface controller 200 may be most any size and shape. In some embodiments, the user interface controller 200 does not include the display 852. In some embodiments, the user interface controller 200 is a remote control having buttons and no screen, such as an infrared remote, an RF remote, or a Bluetooth remote. In some embodiments, the user interface controller 200 is a tablet mounted to a wall or other surface and positioned to be engagable by a user.

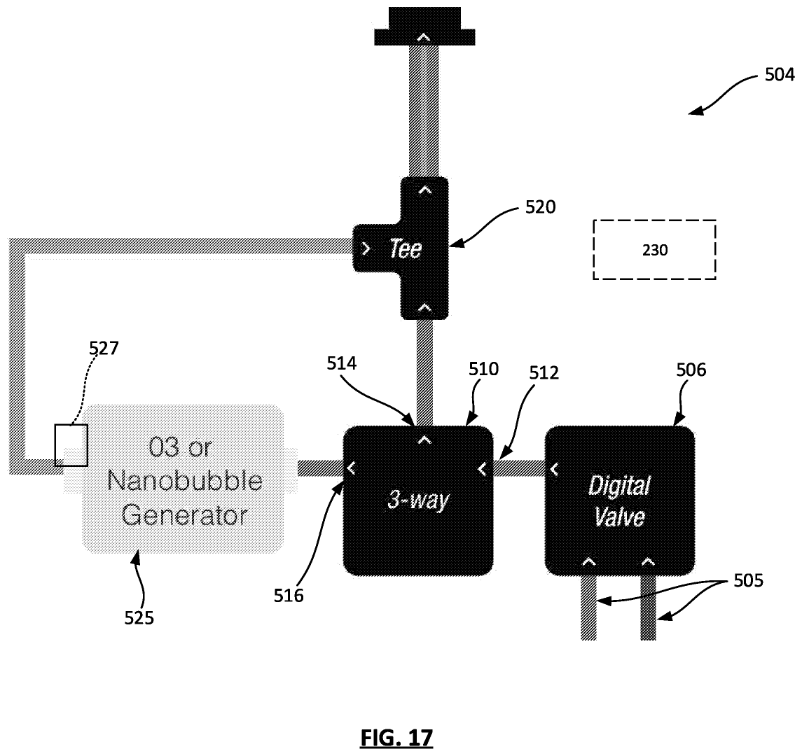

Referring now to FIG. 17, a water treatment system 504 is shown, according to an example embodiment. The water treatment system 504 is configured to receive a flow of water, selectively provide a treatment to the flow of water, and provide the flow of water to a fixture, such as the fixture 102, the fixture 202, the first fixture 402, and the second fixture 403. In some embodiments, the water treatment system 504 is configured to selectively provide a flow of treated water to a sink faucet, such as that belonging in a kitchen, bathroom, laboratory, hand washing station, and the like. In some embodiments, the water treatment system 504 is configured to selectively provide a flow of water to a bathroom fixture, such as a shower head, shower sprayer, toilet, bidet, foot wash, and the like. In some embodiments, the water treatment system 504 provides a flow of water to a kitchen fixture, such as an ultrasonic wash, sink sprayer, dish washer, and the like. In some embodiments, the water treatment system 504 provides a flow of water to an appliance, such as a laundry machine, steamer, carpet cleaner, fire suppression system, and the like.

The water treatment system 504 includes a first valve assembly 506 configured to receive an unmixed flow of water, such as from hot and cold supply lines 505. The first valve assembly 506 may be a digital valve configured to be controlled by a controller (e.g., the system controller 230, the handle control 116, the module interface 258, etc.) communicatively coupled to the first valve assembly 506. For example, the user interface controller 200 may be coupled to the fixture and communicatively coupled to the system controller 230, the user interface controller 200 shown in FIGS. 18-20 as a faucet controller (e.g., the faucet controller 540, the faucet controller 560, or the faucet controller 570). The faucet controller is configured to send a signal to the system controller 230 in response to a user interaction with the faucet controller. The faucet controller may send the signal to the system controller 230 via a wired or a wireless connection. The system controller 230 receives the signal from the faucet controller and operates the first valve assembly 506 to control a flow of water from the first valve assembly 506. The first valve assembly 506 may be operated to control a flow rate and a temperature of a flow of water. In some embodiments, the fixture does not include a valve (e.g., mixing valve) such that no valves or valve assemblies are positioned above the surface 101.

The water treatment system 504 further includes a second valve assembly 510 fluidly coupled to the first valve assembly 506 and positioned downstream of the first valve assembly 506. The second valve assembly 510 is configured to receive a flow of water through an inlet 512 of the second valve assembly 510 and provide a flow of water through at least one of the first outlet 514 and the second outlet 516 of the second valve assembly 510. The second valve assembly 510 is communicatively coupled to the system controller 230 such that a user interaction with the user interface controller 200 controls operation of the second valve assembly 510. For example, a user interaction with the control puck 848 may configure the second valve assembly 510 such that all of the water received via the inlet 512 is discharged from the second valve assembly 510 via the first outlet 514 and water is prevented from flowing out of the second outlet 516. In some embodiments, a user interaction with the control puck 848 may cause 20% of the inlet flow to flow out of the first outlet 514, and allow 80% of the inlet flow to flow out of the second outlet 516. In some embodiments, the second valve assembly 510 is a passive connector that does not include a valve or a valve assembly.

The water treatment system 504 further includes a treatment device 525 configured to receive a flow water from the second outlet 516 and selectively provide a treatment to the flow of water flowing through the treatment device 525. In some embodiments, the flow of water does not flow through, but flows past the treatment device 525, and the treatment device 525 is configured to provide a treatment to the flow of water flowing past the treatment device 525. In some embodiments, the treatment device 525 is configured to actuate in response to a flow of water flowing through the treatment device 525. For example, the treatment device 525 may include a flow sensor 527 that measures a flow of water through the treatment device 525 and/or a temperature of water flowing through the treatment device 525 and/or a flow rate of water flowing through the treatment device 525. In some embodiments, the treatment device 525 is turned off in response to receiving a signal from the system controller 230 that the faucet controller is in an off position and/or that the system controller 230 received an off command from the faucet controller. When the faucet controller is operated to send an “on” signal to the system controller 230, the system controller 230 sends a signal to the first valve assembly 506 to turn on and allow a flow of water to flow through the first valve assembly 506 and thus the fixture. At the same time that the system controller 230 send the “on” signal to the first valve assembly 506, the system controller 230 sends a signal to the treatment device 525 to enter a “stand-by” mode, where the flow sensor 527 detects a flow rate and a temperature of water flowing through the treatment device 525. In some embodiments, the treatment device 525 is configured to operate in response to a flow rate of water and/or a temperature of water. For example, in embodiments where the treatment device 525 is an ozone generator, the treatment device 525 activates when a flow of water through the treatment device 525 reaches a threshold temperature (100° F., 115° F., etc.). In some embodiments, the treatment device 525 activates in response to the flow sensor 527 sensing a threshold flow rate (e.g., 0.5 gallons per minute, 1 gallon per minute, 1.5 gallons per minute, etc.). In some embodiments, the treatment device 525 changes the fluid treatment in response to the flow rate. For example, in embodiments where the treatment device 525 is an electrolytic ozone generator, the treatment device 525 may adjust an output voltage of the electrodes of the electrolytic ozone generator in response to detecting a threshold flow rate with the flow sensor 527. For example, the output voltage of the treatment device 525 may be less when the flow sensor 527 measures a flow rate of one gallon per minute than when the flow sensor 527 measures a flow rate of two gallons per minute. In some embodiments, the treatment device 525 is configured to automatically adjust a parts-per-million output in response to a measured flow rate. For example, if the user interface controller 200 is set to 3 PPM, the treatment device 525 may need to adjust the output (e.g., voltage output, concentrate output, etc.) based on the flow rate measured by the flow sensor 527. For example, the treatment device 525 may provide a lesser treatment (e.g., lower voltage, less concentrate) to the flow of water when the flow rate is less in order to maintain a consistent concentration of treatment across various flow rates.

In some embodiments, the flow sensor 527 measures a concentration of ozone in the flow of water and adjusts the output of the treatment device 525 in response to a measurement of the concentration of the flow of water. For example, during the life time of the treatment device 525, the electrodes may become coated in insolvable salts. As the electrodes become coated, the treatment device 525 may require a greater voltage output to deliver the desired concentration than were required earlier in the life time of the treatment device 525. Accordingly, the flow sensor 527 may directly measure the concentration outlet of the treatment device 525 and automatically adjust the output voltage of the treatment device 525 to achieve the desired concentration received from the user interface controller 200 (e.g., the control puck 848, the faucet controller 540, 560, 570, etc.).

The water treatment system 504 further includes a tee-connector 520 that is configured to receive a flow of water from both the first outlet 514 of the second valve assembly 510 and from the treatment device 525. The tee-connector 520 is not able to selectively prevent a flow of water from flowing through the tee-connector 520. In other words, the tee-connector 520 is a passive connector that cannot be controlled to selectively prevent a flow of water from entering or exiting the tee-connector 520. While the tee-connector 520 is shown as being downstream from the second valve assembly 510 in FIG. 17, in some embodiments, the tee-connector 520 and the second valve assembly 510 may switch placed such that the second valve assembly 610 is downstream from the tee-connector 520.

Referring now to FIG. 18, the user interface controller 200 is shown, according to an example embodiment, as a faucet controller 540. The faucet controller 540 is coupled to a base (e.g., the base 210) of a fixture, shown as a fixture 502. The fixture 502 is similar to the fixture 202. Accordingly, like numbering is used to denote like parts between the fixture 502 and the fixture 202. A difference between the fixture 502 and the fixture 202 is that the fixture 502 does not include the handle control 116. The faucet controller 540 includes a controller indicator 542, a dial 544, and a toggle 546. The controller indicator 542 is similar to the fixture indicator 246 and includes a light, such as a color changing light that changes based on the operating status of the water treatment system 504. The controller indicator 542 may have various modes, including flashing, breathing (slowly turning on and off), blinking slowly and quickly, spinning (multiple discrete lights positioned below a diffuser that chase each other circumferentially around the controller indicator 542). The controller indicator 542 may also change color based on the status of either the fixture 502 or the water treatment system 504. In embodiments where the water treatment system 504 is coupled to a spigot or spout, the faucet controller 540 is communicatively coupled to the system controller 230 but is not physically coupled to a valve, as there may be no valve in the fixture 502, as all the valves of the water treatment system 504 are positioned below the countertop.

The dial 544 is configured to control the flow of water provided by the water treatment system 504 to the fixture 502. In some embodiments, the dial 544 is continuously rotatable such that the dial 544 may be rotated continuously in either rotational direction without stopping. In some embodiments, the dial 544 is rotationally limited such that the dial 544 is operable between a first position (e.g., lower limit, off position, etc.) and a second position (e.g., upper limit, maximum position), where the first position and the second position are separated by a predetermined amount of rotational degrees. In some embodiments, the predetermined amount of rotational degrees is less than 360° (less than a full rotation). In some embodiments, the predetermined rotational degrees is greater than 360° such that the dial 544 is able to be rotated multiple times around before reaching either the upper limit or the lower limit.

The dial 544 may be configured to change most any flow characteristic of the flow of water provided by the water treatment system 504 and/or discharged by the fixture 502. In some embodiments, rotation of the dial 544 controls the temperature of the water, the flow rate of the water, a concentration of treatment to the water, a time duration of the treatment provided to the water, a status of the treatment device 525 (e.g., on/off), a spray pattern provided by the fixture 502, and the like. In some embodiments, engagement with the faucet controller 540 controller operation of one of the enhancement module 222 coupled to the first fluid conduit 115 and/or the second fluid conduit 126, 844. In some embodiments, the dial 544 controls one or more of the aforementioned features, where the feature the dial 544 controls is selected by a separate user input provided to the toggle 546 or a separate user interface controller (e.g., the control puck 848). In some embodiments, such as when the dial 544 is rotationally limited, the dial 544 being positioned in the first position may prevent a flow of water from flowing through both the water treatment system 504 and the fixture 502, where water is discharged from the fixture 502 in response to the dial 544 transitioning out of the first position. In embodiments where the dial 544 turns on and off the fixture 502 (e.g., starts and stops a flow of water through the water treatment system 504 and the fixture 502), the dial 544 may control either a temperature of the water, a flow rate of the water, a status of the treatment device 525, and any other feature of the water treatment system 504. It can be appreciated that discrete control over a flow rate is not always necessary, as is the case with many showers, automatic faucets (often found in public restrooms), and many kitchen faucets. Therefore, the dial 544 may serve a binary purpose, providing an “off” signal when in the first position, and providing an “on” signal simultaneously with another control signal (e.g., temperature, treatment concentration, etc.) when moved out of the first position.

The toggle 546 may be substantially circular and positioned radially within the dial 544. In other words, the faucet controller 540 defines a substantially annular shape, where the dial 544 is configured to rotate about the circumference of the faucet controller 540 and the toggle 546 is positioned proximate to a middle of the faucet controller 540. The toggle 546 may include a plurality of control interfaces (e.g., buttons, sensors, switches, etc.), shown, by way of example and not meant to be limiting, as a first button 550, a second button 552, and a third button 554. The first button 550 is positioned proximate to the center of the toggle 546 and proximate a center axis of the dial 544. The first button 550 may be a power button configured to start and stop a flow of water through the fixture 502 and/or turn on and off a treatment device (e.g., the treatment device 260, 410, 525).

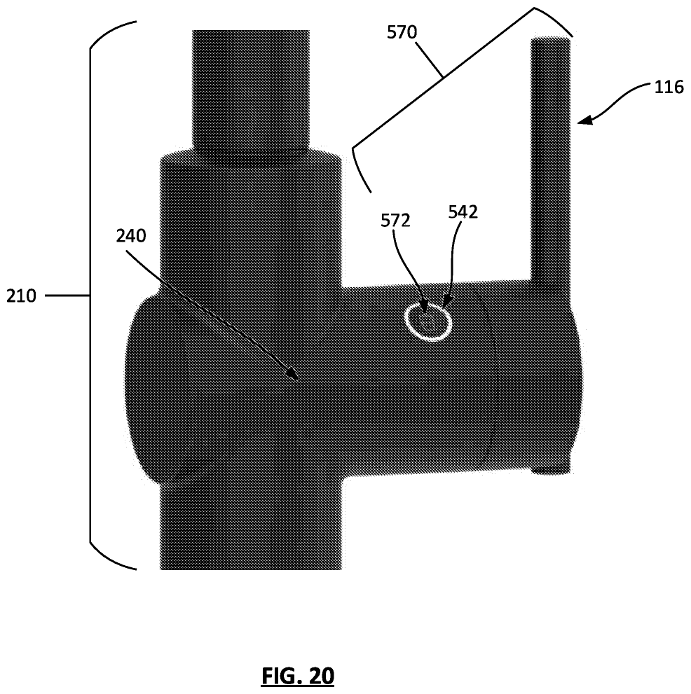

Referring now to FIG. 19, a faucet controller 560 is shown coupled to a base (e.g., the base 210) of a fixture, shown as the fixture 502. The faucet controller 560 is similar to the faucet controller 540 of FIG. 18. Accordingly, like numbering is used to denote like parts between the faucet controller 560 and the faucet controller 540. A difference between the faucet controller 540 and the faucet controller 560 is that the faucet controller 560 includes the handle control 116 instead of the dial 544.

The faucet controller 560 includes the controller indicator 542, the handle control 116, and the toggle 546. The controller indicator 542 includes a light, such as a color changing light that changes based on the operating status of the water treatment system 504. The controller indicator 542 may have various modes, including flashing, breathing (slowly turning on and off), blinking slowly and quickly, spinning (multiple lights positioned below a diffuser chase each other circumferentially around the controller indicator 542). The controller indicator 542 may also change color based on the status of either the fixture 502 or the water treatment system 504. In embodiments where the water treatment system 504 is coupled to a spigot or spout, the faucet controller 560 is communicatively coupled to the system controller 230 but is not coupled physically coupled to a valve, as there may be no valve in the fixture 502, as all the valves of the water treatment system 504 are positioned below the countertop. The controller indicator 542 extends circumferentially about the base 210 of the fixture 502 between the handle control 116 and the surface 101. In some embodiments, the controller indicator 542 is positioned between the faucet controller 560 and the first spray head 214.

The handle control 116 is configured to control the flow of water provided by the water treatment system 504 to the fixture 502. Coupled to the handle control 116 is the toggle 546. The toggle 546 may be substantially circular and positioned radially within a portion of the handle control 116. In some embodiments, the toggle 546 is movable with the handle control 116. In some embodiments, the toggle 546 is fixed to the base 210 such that movement of the handle control 116 does not cause movement of the toggle 546. The toggle 546 may include a single control interface (e.g., button, sensor, switch, etc.), shown, by way of example and not meant to be limiting, as the first button 550. The first button 550 may be a power button configured to start and stop a flow of water through the fixture 502 and/or turn on and off a treatment device.

Referring now to FIG. 20, a faucet controller 570 is shown coupled to a base (e.g., the base 210) of the fixture 502. The faucet controller 570 is similar to the faucet controller 560. Accordingly, like numbering is used to denote like parts between the faucet controller 560 and the faucet controller 570. A difference between the faucet controller 560 and the faucet controller 570 is that the faucet controller 570 includes a control body interface 572 positioned on the control body 240 and positioned away from the handle control 116. The control body interface 572 may be a push button or capacitive sensor similar to any of the first button 550, the second button 552, and the third button 554. In some embodiments, engagement of the control body interface 572 by a user sends instructions to the system controller 230 to activate the treatment device (e.g., the treatment device 260, the treatment device 410, the treatment device 525) when a start commend is received by the system controller 230, such as from the handle control 116. For example, pressing and holding the control body interface 572 for a pre-determined amount of time (e.g., three seconds, five seconds, etc.) may send a signal to the system controller 230 with instructions to maintain the treatment device in a stand-by mode until a flow of water is started through the fixture 502, at which time the system controller 230 activates the treatment device. In some embodiments, the handle control 116 having the handle sensor 120 sends the start command to the system controller 230 when the handle sensor 120 detects that the handle control 116 has been moved out of the off position. Moving the handle control 116 away from the off position and back to the off position may reset the control body interface 572 such that the system controller 230 defaults to maintaining the treatment device in a stand-by or off status in response to receiving the start flow command, such as from the handle control 116 or the user interface controller 200.

The faucet controller 570 includes the controller indicator 542, the handle control 116, and the control body interface 572. The controller indicator 542 includes a light, such as a color changing light that changes based on the operating status of the water treatment system 504. The controller indicator 542 may border the control body interface 572 (e.g., circumferentially surround the control body interface 572). The controller indicator 542 has various modes, including flashing, breathing (slowly turning on and off), blinking slowly and quickly, spinning (multiple lights positioned below a diffuser chase each other circumferentially around the controller indicator 542). The controller indicator 542 may also change color based on the status of either the fixture 502 or the water treatment system 504. In embodiments where the water treatment system 504 is coupled to a spigot or spout, the faucet controller 570 is communicatively coupled to the system controller 230 but is not coupled physically coupled to a valve, as there may be no valve in the fixture 502, as all the valves of the water treatment system 504 are positioned below the countertop.

Referring now to FIG. 21, the system controller 230 is shown, according to an example embodiment. The system controller 230 includes a processor 580, a memory 582, a network interface 584, and an input/output circuit 586. The system controller 230 as described may be included in any of the faucet systems (e.g., faucet system 100, 300, 400), water treatment systems (e.g., water treatment system 104, 304, 404, 504), fixtures (fixture 102, 202, 302, 502, second fixture 403), and enhancement modules 222 outlined above. The system controller 230 receives signals from a water treatment system (e.g., the water treatment system 104, 304, 404, 504) and received inputs from a user interface controller (e.g., the module interface 258, the user interface controller 200, the faucet controller 540, 560, 570, the handle control 116, etc.). In some embodiments, the system controller 230 receives signals from other water systems, such as a fixture, a faucet, spigot, shower head, and the like. The system controller 230 may also receive inputs from various other user devices, such as a mobile cellular device, personal computer, remote control (RF remote, IR remote, Bluetooth remote, etc.), voice assistant (e.g., Siri, Google Assistant, Alexa, etc.), an internet-of-things device (IOT device, Apple Home Pod, Amazon Echo device, Google Nest device, etc.), and the like. In some embodiments, the system controller 230 is communicatively coupled to the water treatment system via a wired connection.

The system controller 230 may be communicatively coupled to the water treatment system and/or the user interface controller via a network 590. In some embodiments, the network 590 includes the Internet. In other arrangements or combinations, the network 590 can include a local area network and/or a wide area network. The operation of the network 590 is facilitated by short and/or long-range communication technologies, such as Bluetooth® transceivers, Bluetooth® beacons, RFID transceivers, NFC transceivers, Wi-Fi transceivers, cellular transceivers, microwave transmitters, software radio, wired network connections (e.g., Ethernet), etc. The network 590 may be a packet-switched network, wherein one or more systems shown in FIG. 16 may exchange data using one or more communication protocols, such as a TCP, UDP, SCTP, ICPMv4, ICMPv6, etc. Various components of the environments of FIG. 16 include network (communications) interfaces, such as the network interface 584. The communications interfaces may include various circuitry programmed to communicate via the network 590, such as transceivers, interface engines, etc.

Although shown in the embodiment of FIG. 21 as singular, stand-alone devices, one of ordinary skill in the art will appreciate that, in some embodiments, the system controller 230, the user interface controller, and the water treatment system may comprise virtualized systems and/or system resources. In some embodiments, the system controller 230 and the water treatment system may share physical storage, hardware, and other resources with each other and/or with other virtual machines.

The system controller 230 is shown to include the processor 580, the memory 582, and the network interface 584. The memory 582 may store machine-executable instructions that, when executed by the processor 580, cause the processor 580 to perform one or more of computer operations. The processor 580 may include one or more microprocessors, application specific integrated circuits (ASICs), field programmable gate arrays (FPGAs), other forms of processing circuits, or combinations thereof. The memory 582 may include, but is not limited to, electronic, optical, magnetic, or any other storage or transmission device capable of providing the processor 580 with program instructions. The memory 582 may include storage devices such as a floppy disk, CD-ROM, DVD, magnetic disk, memory chip, ROM, RAM, EEPROM, EPROM, flash memory, optical media, or any other suitable memory from which the processor 580 can read instructions and/or data. At least the processor 580 and the memory 582 may form a processing module. Further circuitry, such as the components and circuits described further herein, may be included in the processing module.

The system controller 230 further includes the input/output circuit 586. The input/output circuit 586 is communicatively coupled to the processor 580, the memory 582, and the network interface 584. The input/output circuit 586 may include hardware and associated logics structured to enable the source water treatment system and the user interface controller to exchange information with the system controller 230. An input device or component of the input/output circuit 586 allows the system controller 230 to receive a signal and/or an input and may include, for example, a mechanical keyboard, a touchscreen, a microphone, a camera, a fingerprint scanner, any user input device engageable with the user interface controller and the water treatment system via a USB, serial cable, Ethernet cable, and so on. In some embodiments, the user interface controller is communicatively coupled to the input/output circuit 586 and is configured to provide an input to the system controller 230 and cause the controller to complete an action, such as controlling a device of the water treatment system or updating the firmware of the devices associated with the water treatment system. An output device or component of the input/output circuit 586 allows the system controller 230 to provide information to a separate computing device or screen, such as the display 852 of the control puck 848. In some embodiments, the output device is a different part of the water treatment system, such as a digital display, a speaker, an LCD screen, illuminating icons, LEDs, and so on.

The water treatment system includes a treatment device (e.g., the treatment device 260, 410, 525) and the first valve assembly 506 communicatively coupled to the system controller 230 and configured to send and receive inputs and signals. The flow sensor 527 is configured to measure a flow of fluid through the treatment device 525 and send a signal to the system controller 230, the signal being indicative of one of a flow rate, a temperature, and a concentration of the flow of water flowing through the treatment device 525. In some embodiments, the flow sensor 527 is upstream from the treatment device 525 and is configured to measure a flow of water entering the treatment device 525. In some embodiments, the flow sensor 527 is positioned downstream from the treatment device 525 such that the flow sensor 527 may measure the treatment provided to the flow of fluid, such as by measuring a concentration, an acidity, a pH, a temperature, a conductivity, and similar attributes of the treated flow of water.

The system controller 230 is configured to receive a plurality of inputs (e.g., control signals, control inputs, commends, etc.) from the user interface controller. A user interaction with any of the dial 850, the display 852 (e.g., touch screen), the toggle 546, the user interface controller 200, the handle control 116, and the module interface 258, and the faucet controller 540, 560, 570 may send an input to the system controller 230 and cause the system controller 230 to send a command to a device of the water treatment system. In some embodiments, operation of the treatment device may be configured by the user via the user interface controller while the water treatment system is in an off or stand-by status (e.g., while water is not flowing through the water treatment system).

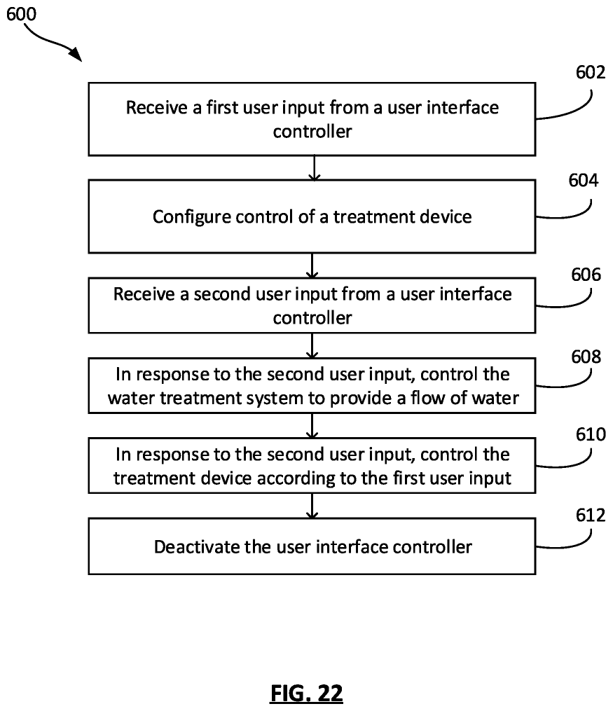

Referring now to FIG. 22, a method 600 of configuring and controlling a faucet system, according to an example embodiment. At 602, the system controller 230 receives a first input from a user interface controller (e.g., the user interface controller 200). In some embodiments, the first input is an activation request for a treatment device. In some embodiments, the first input is a start request to start a flow of water through the faucet system (e.g., a water treatment system and a fixture) while simultaneously activating the treatment device.

At 604, the system controller 230 configures control of the treatment device according to the first input. In some embodiments, the treatment device includes an onboard processor (e.g., a processor in communication with the system controller 230 via the fitting 227) and the system controller 230 configures the onboard processor and/or sends instructions to the onboard processor for operating the treatment device. In some embodiments, the treatment device does not include a local processor and the system controller 230 is configured to control the treatment device directly. For example, the first input may command the system controller 230 to configure control of the treatment device such that the treatment device remains powered off in response to starting a flow of water through the water treatment system, such as via an interaction with the user interface controller. In some embodiments, the first input may commend the system controller 230 to configure control of the treatment device such that the treatment device is activated in response to starting a flow of water through the faucet system.

At 606, the system controller 230 receives a second user input from a user interface controller. The second user input may be received from the same user interface controller that provided the first user input. In some embodiments, the second user input is received from a user interface controller that is different from the user interface controller that provides the second user input. The second user input may be a request to start a flow of water through the water treatment system and out of the fixture.

At 608, the system controller 230 controls the water treatment system to provide a flow of water in response to the second user input. The second user input is a signal that commands the system controller 230 to control the water treatment system to start a flow of water through the water treatment system and provide the flow of water to a fixture, such as a sink faucet, sink sprayer, shower head, and the like.

At 610, the system controller 230 controls (e.g., activates) the treatment device in response to receiving the second user input. In some embodiments, the system controller 230 controls the treatment device according to the first user input received by the system controller 230 before the second user input was received by the system controller 230. For example, if the first user input was a command to maintain the treatment device in a stand-by or off status, the system controller 230 would maintain the treatment device in an off or stand-by status in response to receiving the second user input. In other words, an interaction with the power button would start of flow of water through the water treatment system and out of the fixture, but the treatment device would be off such that the treatment device does not provide a treatment to the flow of water. In some embodiments, such as when the first input is a command to activate the treatment device, the system controller 230 maintains the treatment device in an off or stand-by status until the system controller 230 receives the second user input. In response to receiving the second user input, the system controller 230 activates the treatment device at the same time that the system controller 230 starts a flow of water through and out of the water treatment system. In some embodiments, the first user input includes a time delay, and the system controller 230 starts a flow of water through the faucet system before activating the treatment device after the time delay.

In some embodiments, the first user input is a combination of commands received from the user interface controller, such as the user interface controller 200. As outlined above with respect to FIGS. 15 and 16, the user interface controller 200 may provide both a status command and a control command (e.g., concentration command) to the system controller 230. For example, if the treatment device is an ozone generating device, the first input may include a status command and a concentration command, where the status commend indicates to the system controller 230 whether to activate the treatment device in response to the second user input, and the concentration commend indicates to the system controller 230 how to control the treatment device. In some embodiments, the first input further includes a delay, the delay being a predetermined non-zero period of time (e.g., 1 second, 3 seconds, 5 seconds, etc.). If the first user input includes a delay, the system controller 230 may control the treatment device to activate in response to the second user input, but only after the delay. For example, in response to the second user input, the system controller 230 may begin a flow of water through the treatment device while the treatment device is powered off. After the delay, and before a third user input is received to turn off the flow of water, the system controller 230 activates the treatment device to provide a treatment to the flow of water. This may be advantageous in embodiments where activating the treatment device dry (e.g., without any water) could damage or reduce the life of the treatment device.

At 612, the system controller 230 inactivates the user interface controller that provided the first user input such that the configuration of the treatment device 525 cannot be changed while water is flowing through and being discharged from the faucet system.

Referring now to FIGS. 23-31, a faucet system 900 is shown, according to an example embodiment. The faucet system 900 is similar to the faucet system 400. Accordingly, like numbering is used to denote like parts between the faucet system 400 and the faucet system 900.

The faucet system 900 includes a first fixture 902, a second fixture 403, and a water treatment system (e.g., water treatment system 104, 304, 404, 504). The first fixture 902 is similar to the fixture 102. Accordingly, like numbering is used to denote like parts between the fixture 102 and the first fixture 902. A difference between the first fixture 902 and the fixture 102 is that the first fixture 902 does not include the second spray head 124. Instead, the faucet system 900 includes the second fixture 903 retractable into the surface 101. The second fixture 903 is similar to the second fixture 403. Accordingly, like numbering is used to denote like parts between the second fixture 403 and the second fixture 903. The second fixture 903 may be fluidly isolated from the first fixture 902 such that two different flows of water may be discharged from the first fixture 902 and the second fixture 903 at the same time. For example, a flow of microbubble water may be discharged from the first fixture 902 while, simultaneously, a flow of steam is provided by the second fixture 903.

The water treatment system of the faucet system 900 is configured to receive a flow of water, selectively provide a treatment to the flow of water, and provide the flow of water to one of or both of the first fixture 902 and the second fixture 903. For example, the water treatment system may discharge ozonated water, filtered water, water having a concentrate, water having bubbles, electrolyzed water, pH-adjusted water, steam, heated water, and the like.

The second fixture 903 includes a second spray head 942 and the second fluid conduit 844 extending between, and fluidly coupling, the second spray head 942 and the water treatment system. In some embodiments, an electrical conduit 846 extends along the length of the second fluid conduit 844 and communicatively couples the second spray head 942 to the system controller 230 of the faucet system 900. The electrical conduit 846 is configured to carry a data signal, power, or both power and a data signal.

The second spray head 942 may be the enhancement module 222 that is configured to provide a treatment to the fluid received from the water treatment system. For example, the water treatment system may not include a treatment device such that the enhancement module 222 is providing the only treatment to the second flow of water discharged from the second spray head 942. In some embodiments, the enhancement module 222 and a treatment device of the water treatment system are both configured to provide a treatment to the second flow of water. For example, the treatment device of the water treatment device may ozonate the second flow of water, and the enhancement module 222 may selectively discharge a concentrate into the second flow of water. The second spray head 942 may be removably coupled to the second fluid conduit 844 such that the second spray head 942 is replaceable with any of the enhancement modules 222 outlines above. The second fluid conduit 844 may include a fitting configured for coupling with the enhancement module 222 and structure to provide power and/or data to the enhancement module 222 via the electrical conduit 846.

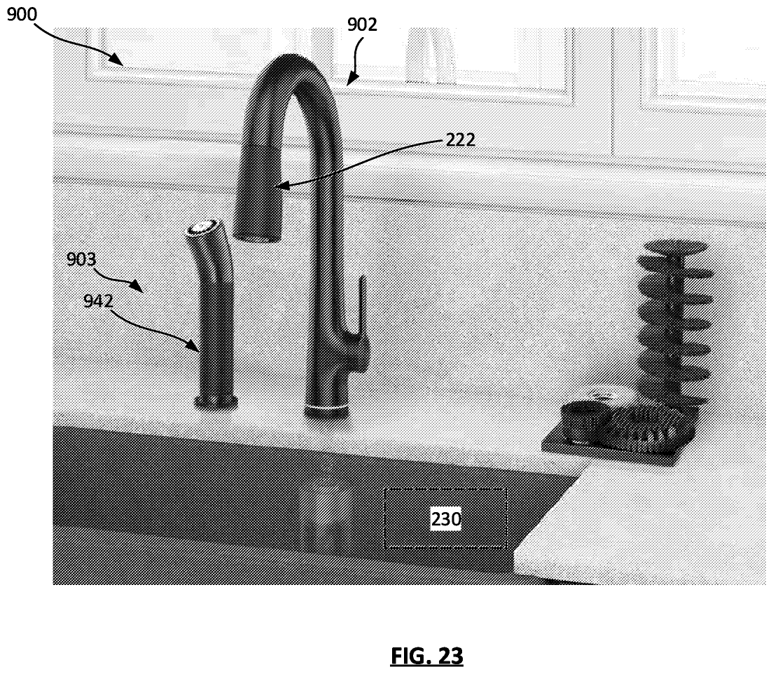

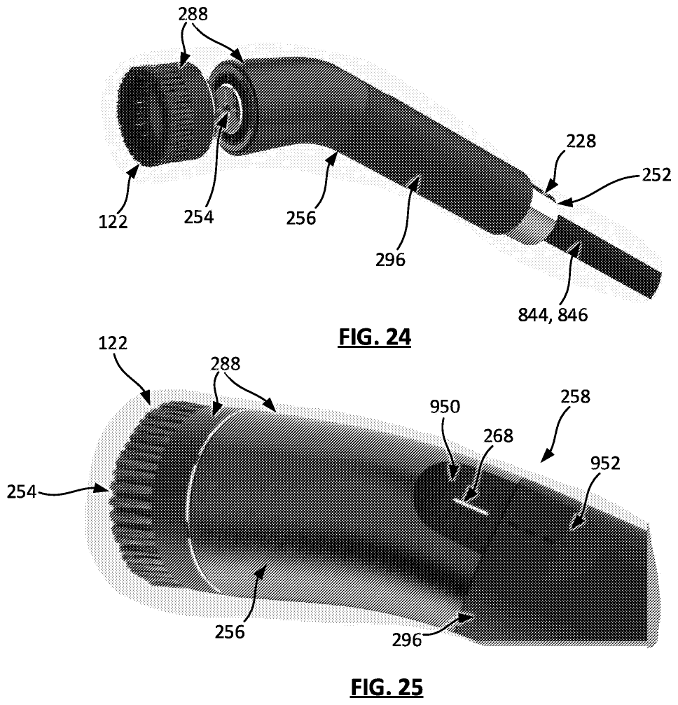

Referring now to FIGS. 24 and 25, the second fixture 903 is shown as a steam wand 903. The steam wand 903 is similar to the steam module 128. Accordingly, like numbering is used to denote like parts between the steam wand 903 and the steam module 128. The steam wand includes the module interface 258 configured to send a signal to one of the water treatment system or a steam generator and valve assembly positioned within the steam wand 903. When a user interacts with (e.g., presses, touches, switches, etc.) the module interface 258, steam is discharged from the second spray head 842.

The steam device is configured to receive a flow of water and output steam via the outlet 254. The steam wand 903 includes a heat insulating jacket 296, such as one made of silicone, that surrounds the cylindrical body 256 and remains cool to the touch while the steam device is active. The steam device may be communicatively coupled to the system controller 230 via the electrical conduit 846. In some embodiments, the steam wand 903 is fixedly coupled to the second fluid conduit 844 such that the steam wand 903 cannot be decoupled from the second fluid conduit 844 without deformation of either the steam wand 903 or the second fluid conduit 844. The system controller 230 is configured to selectively activate or deactivate the steam wand 903 (e.g., the steam generator positioned within the steam wand 903) in response to a user interaction with the faucet system 900 (e.g., the user interface controller 200, the module interface 258). In some embodiments, the system controller 230 prevents activation of the steam wand 903 when the steam wand 903 is in a docked position. In some embodiments, re-docking the steam wand 903 to a fixture positioned on the surface 101 automatically deactivates the steam wand 903. In some embodiments, the system controller 230 is configured to activate the steam wand 903 only when (e.g., after) certain conditions of the faucet system 900 are met. For example, in order to activate the steam wand 903 with the module interface 258, the flow of water should reach a certain temperature (e.g., 100° F.). When the water reaches the predetermined temperature, the system controller 230 activates the module interface 258 and allows the user to activate the steam wand 903 after removing the steam wand 903 from the fixture positioned on the surface 101. In some embodiments, the system controller 230 automatically activates the steam wand 903 in response to certain conditions being met. For example, when the flow of water through the steam wand 903 reaches a predetermined temperature, the system controller 230 may activate the steam wand 903 and turn on the module indicator 268 to signal to the user that the steam wand 903 is ready for use. The scrubbing device 288 coupled to the steam wand 903 may include a heat resistant brush 122 having hard bristles.

The module interface 258 of the steam wand 903 includes a first button 950 and a second button 952. The first button 950 and the second button 952 may be push buttons, capacitive buttons, and similar sensors. The first button 950 behaves as a toggle switch, where a first interaction with the first button 950 starts a flow of steam from the steam wand 903, and a second interaction with the first button 950 stops a flow of steam from the steam wand 903. Positioned proximate to the center of the first button 950 is the module indicator 268. The second button 952 abuts the first button 950, and the second button 952 is a pushbutton. In other words, the second button 952 is configured such that the second button 952 must be depressed in order to begin a flow of steam from the steam wand 903. When the second button 952 is lifted up (e.g., not depressed), the second button 952 sends a signal to the system controller 230 to stop a flow of steam from the steam wand 903.

The faucet system 900 further includes the user interface controller 200 configured to provide a signal to the system controller 230 of the faucet system 900. The user interface controller 200 allows a user to control the output of the first fixture 902 and the steam wand 903. For example, where the enhancement module 222 is an ozone module (e.g., the ozone module 250), the user interface controller 200 may set an ozone status, such as “on” or “off,” and an ozone setting, such as a desirable parts per million (PPM) of ozone concentration. When the ozone status is set to “on,” activation of the module interface 258 simultaneously activates the ozone module and starts a flow of water through the faucet system 400. In some embodiments, when the ozone status is set to “on,” engagement with the module interface 258 causes a flow of water to flow through the second fixture 403. After a pre-determined non-zero time delay (e.g., 1 second, 3 seconds, etc.), the system controller 230 activates the ozone module to provide a treatment to the flow of water flowing through the second spray head 842. The aforementioned configuration may be desirable where activating the enhancement module 222 without water could cause damage to the enhancement module 222. In some embodiments, the steam wand 903 includes the module indicator 268 that visually indicates to the user the steam generator status. For example, a yellow light may be displayed to indicate that the steam wand 903 is in a stand-by mode such that a start signal (e.g., a signal that starts a flow of water through the steam wand 903, from the handle control 116) causes activation of the steam generator and causes a flow of steam to exit the steam wand 903. In some embodiments, a green light may be displayed to indicate that the steam wand 903 is in a non-treatment mode, or that the steam wand 903 is discharging a flow of water (e.g., non-steam).

The user interface controller 200 may be further configured to control various other enhancement modules 222 coupled to the first fixture 902. For example, the enhancement module 222 may be a scrubbing module (e.g., the scrubbing module 294) that includes a module reservoir (e.g., the module reservoir 286) and a scrubbing device (e.g., the scrubbing device 288). When the scrubbing module is coupled to the fitting 227 of the first fixture 902, the scrubbing module may send a signal to the system controller 230 that the scrubbing module has been coupled to the first fluid conduit 115. After the controller receives a signal from the scrubbing module that the scrubbing module has been coupled to the first fixture 902, the user interface controller 200 may update to provide controls for operating the scrubbing module. In some embodiments, the user interface controller 200 may include a touch screen (e.g., touch display) that updates in response to detecting which module is coupled to the first fixture 902. As outlined above, any of the steam module 128, the ozone module 250, the bubble module 280, the concentrate module 284, and the scrubbing module 294 may send a signal to the user interface controller 200 to update the display 852.

Referring now to FIG. 26, the fitting 905 of the first fluid conduit 115 is shown. The fitting 905 is configured for coupling to be fluidly coupled with and communicably coupled with the enhancement module 222. The fitting 905 includes a sleeve 906 that extends circumferentially about an end of the first fluid conduit 115. The sleeve 906 may be formed of a metal or polymeric material. Extending radially from the sleeve 906 is tab 908 configured for positioning within a slot of the first fixture 902 when the first fluid conduit 115 is in a retracted position. The tab 908 prevents rotation of the fitting 905 within the neck 112 of the first fixture 902 when the first fluid conduit 115 is in the fully retracted position. The fitting 905 further includes a pair of electrodes 910 configured to communicably couple the enhancement module 222 with the system controller 230. The pair of electrodes 910 are the terminal ends of the first electrical conduit 117 that extends the length of the first fluid conduit 115. In some embodiments, the pair of electrodes 910 provide power only such that the pair of electrodes 910 are voltage positive and voltage negative, respectively. In some embodiments, the pair of electrodes 910 transmit data signals to the enhancement module 222. For example, the enhancement module 222 may include a battery pack and may receive instructions from the system controller 230 via the pair of electrodes 910. The pair of electrodes 910 may be pogo pins, magnetic pins, and the like.

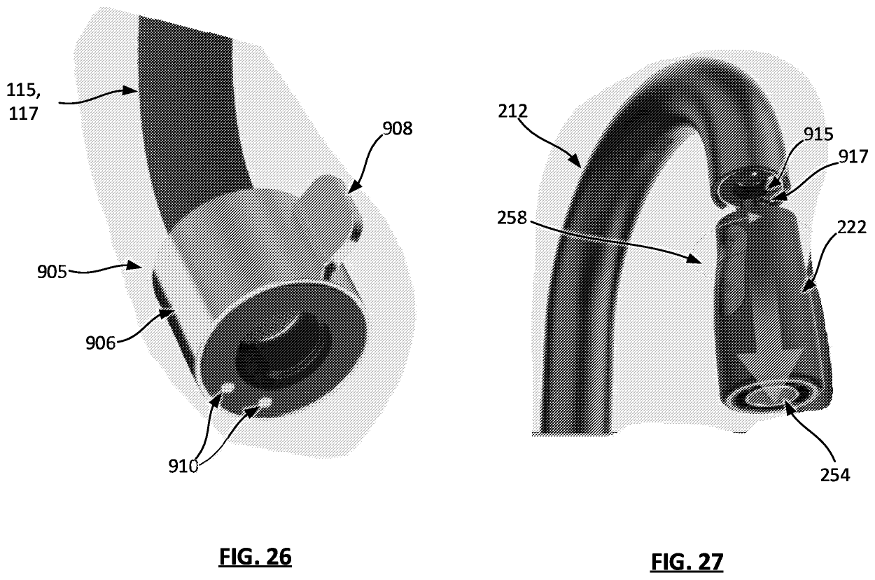

Referring now to FIG. 27, the enhancement module 222 is shown being coupled to the fitting 905. The enhancement module 222 may be removably coupled to the fitting 905 using a quarter-turn bayonet-style coupling, shown as a coupling member 915. The coupling member 915 includes a pair of wings 917 that slide into internal slots of the fitting 905. To remove the enhancement module 222 from the fitting 905, the enhancement module 222 is rotated a quarter-turn counterclockwise and pulled axially from the fitting 905. In some embodiments, the enhancement module 222 includes a detent configured to provide haptic feedback when the enhancement module 222 is properly coupled with the fitting 905 such that the pair of electrodes 910 line up with a corresponding pair of electrodes on the enhancement module 222. In some embodiments, the pair of electrodes on the enhancement module 222 are pogo pins.

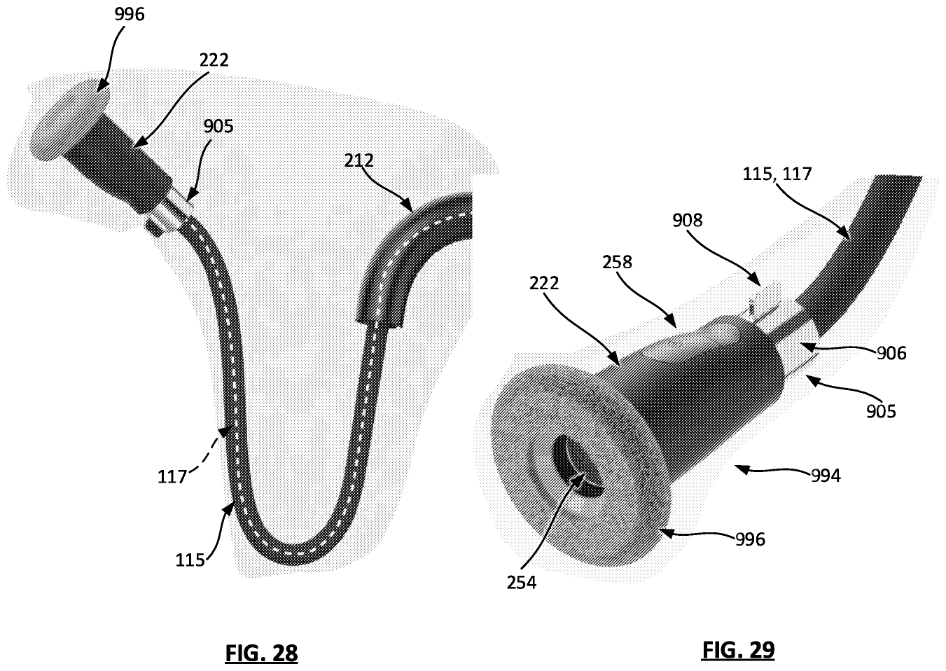

Referring now to FIG. 28, the enhancement module 222 is shown coupled to the fitting 905 and the first fluid conduit 115 is shown in an extended position. The first electrical conduit 117 runs along the first fluid conduit 115 and communicably couples the enhancement module 222 to the system controller 230.

Referring now to FIG. 29, the enhancement module 222 is shown as a scrubbing module 994. The scrubbing module 994 is similar to the scrubbing module 294. Accordingly, like numbering is used to denote like parts between the scrubbing module 294 and the scrubbing module 994. A difference between the scrubbing module 294 and the scrubbing module 994 is that the scrubbing module 994 includes a silicone scrubbing brush 996. In some embodiments, it may be desirable to scrub a surface while dispensing a treated flow of water. For example, a treatment device positioned within the scrubbing module 994 (e.g., the treatment device 260) may be configured to create bubbles in the flow of water to aid with the scrubbing of the silicone scrubbing brush 996. In some embodiments, the brush 996 is removable and replaceable. For example, the brush 996 may become damaged or worn from scrubbing rough surfaces, including cast iron, stove and grill grates, oven racks, and the like. A user may have multiple brushes, each having different brush stiffness and length. As can be appreciated, many attachments may be operably coupled to the scrubbing module 994 for the purposes of cleaning (e.g., sponge, scrub bad, steel wool, wire brush, etc.). The scrubbing module 994 further includes the actuator 290. In some embodiments, the silicone scrubbing brush 996 is operably coupled to the actuator 290 and the actuator 290 scrubbing device is configured to oscillate and/or rotate the brush 996 to provide an improved scrubbing experience. In some embodiments, the scrubbing module 994 receives power via the fitting 905. In some embodiments, the brush 996 is coupled to the enhancement module 222 and is not configured to move independently from the enhancement module 222. In some embodiments, the scrubbing module 994 includes an additional treatment device, such as the bubble generator, the ozone generator, and similar treatment devices.

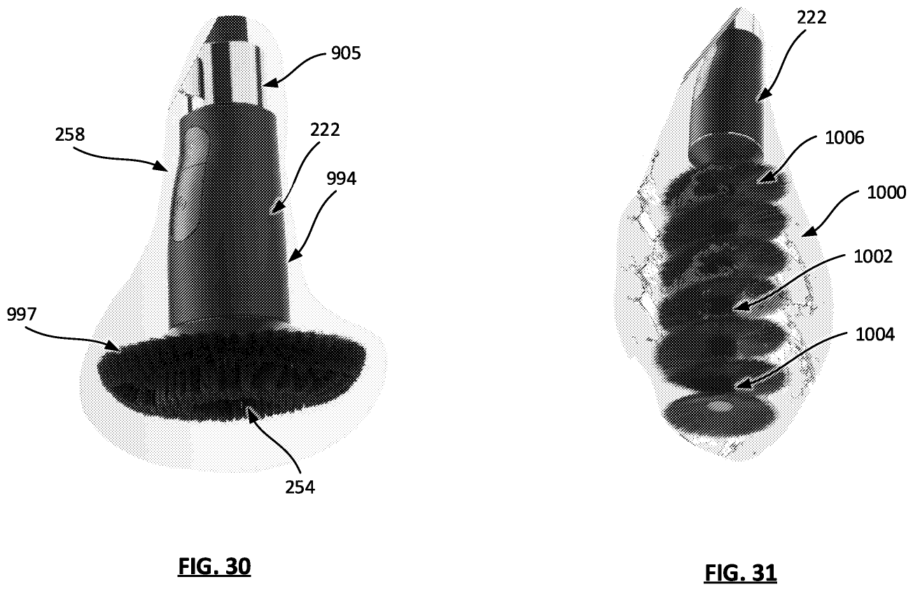

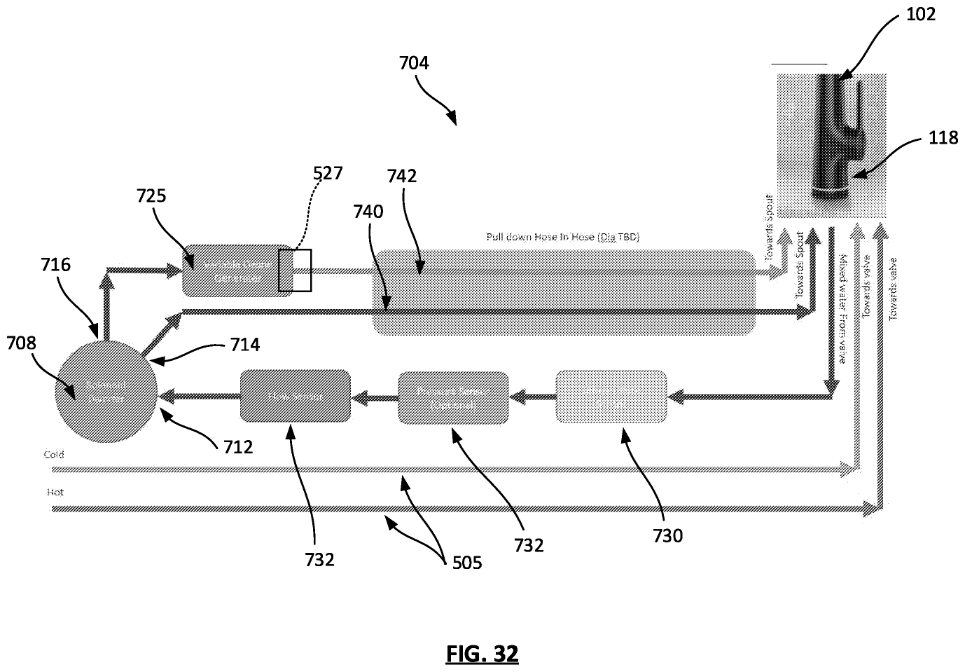

Referring now to FIG. 30, the scrubbing module 994 is shown having a replaceable circular brush 997 operably coupled to the actuator 290. As shown in FIG. 31, the scrubbing module 994 includes a bottle brush 1000. The bottle brush 1000 includes a center pipe 1002 that, when the bottle brush 1000 is coupled to the scrubbing module 994, is in fluid communication with the first fluid conduit 115. The center pipe 1002 includes a plurality of apertures 1004 that extend radially from the center pipe 1002 and are configured to discharge water from radially from the center pipe 1002. The bottle brush 1000 further includes bristles 1006 that are coupled to the center pipe 1002 and extend radially from the center pipe 1002. The bristles 1006 are positioned in a spiral along the length of the center pipe 1002. When the bottle brush 1000 is coupled to the scrubbing module 994, the actuator 290 is operably coupled to the bottle brush 1000 and is configured to rotate the bottle brush 1000 for the purposes of cleaning.

The scrubbing module 994 is similar to the scrubbing module 294. Accordingly, like numbering is used to denote like parts between the scrubbing module 294 and the scrubbing module 994. A difference between the scrubbing module 294 and the scrubbing module 994 is that the scrubbing module 994 includes a silicone scrubbing brush 996. In some embodiments, it may be desirable to scrub a surface while dispensing a treated flow of water. For example, a treatment device positioned within the scrubbing module 994 (e.g., the treatment device 260) may be configured to create bubbles in the flow of water to aid with the scrubbing of the silicone scrubbing brush 996. In some embodiments, the brush 996 is removable and replaceable. For example, the brush 996 may become damaged or worn from scrubbing rough surfaces, including cast iron, stove and grill grates, oven racks, and the like. A user may have multiple brushes, each having different brush stiffness and length. As can be appreciated, many attachments may be operably coupled to the scrubbing module 994 for the purposes of cleaning (e.g., sponge, scrub bad, steel wool, wire brush, etc.). The scrubbing module 994 further includes the actuator 290. In some embodiments, the silicone scrubbing brush 996 is operably coupled to the actuator 290 and the actuator 290 scrubbing device is configured to oscillate and/or rotate the brush 996 to provide an improved scrubbing experience. In some embodiments, the scrubbing module 994 receives power via the fitting 905. In some embodiments, the brush 996 is coupled to the enhancement module 222 and is not configured to move independently from the enhancement module 222. In some embodiments, the scrubbing module 994 includes an additional treatment device, such as the bubble generator, the ozone generator, and similar treatment devices.

Referring now to FIG. 32, a flow diagram of a water treatment system 704 is shown, according to an example embodiment. The water treatment system 704 is similar to the water treatment system 504 shown in FIG. 17. Accordingly, like numbering is used to denote like parts between the water treatment system 704 and the water treatment system 504. The water treatment device 704 is configured for positioning below a countertop in a kitchen environment, such as below the surface 101 of FIGS. 1, 13, 14, and 23.

The water treatment system 704 is configured to receive a flow of water, selectively provide a treatment to the flow of water, and provide the flow of water to a fixture (e.g., the fixture 102, the fixture 202, the first fixture 402, the second fixture 403, etc.). In some embodiments, the water treatment system 704 is configured to provide a flow of water to both a first fixture (e.g., the first fixture 402) and a second fixture (e.g., the second fixture 403). For example, the water treatment system 704 may be configured to provide only a treated flow of water to the second fixture 403, but no non-treated water to the second fixture 403, and the water treatment system 704 may be configured to provide only a non-treated flow of water to the first fixture 402, but not a treated flow of water to the first fixture 402. This may be done to separate potable water from non-potable water, such as when the treated flow of water, now exclusively provided to the second fixture 403, is not suitable for drinking. In some embodiments, the water treatment system 704 is configured to selectively provide a flow of treated water to a sink faucet, such as that belonging in a kitchen, bathroom, laboratory, hand washing station, and the like. In some embodiments, the water treatment system 704 is configured to selectively provide a flow of water to a bathroom fixture, such as a shower head, shower sprayer, toilet, bidet, foot wash, and the like. In some embodiments, the water treatment system 704 provides a flow of water to a kitchen fixture, such as an ultrasonic wash, sink sprayer, dish washer, and the like. In some embodiments, the water treatment system 704 provides a flow of water to an appliance, such as a laundry machine, steamer, carpet cleaner, fire suppression system, and the like.

The water treatment system 704 includes a first valve assembly, shown as the mixing valve 118, configured to receive an unmixed flow of water, such as from hot and cold supply lines 505. The mixing valve 118 may be a digital valve or a manual valve configured to be controlled by a controller (e.g., the system controller 230, the handle control 116, the module interface 258, etc.) communicatively coupled to the mixing valve 118.

The water treatment system 704 further includes a second valve assembly, shown as a solenoid diverter 708, fluidly coupled to the mixing valve 118 and positioned downstream of the mixing valve 118. The solenoid diverter 708 is configured to receive a flow of water through an inlet 712 of the solenoid diverter 708 and provide a flow of water through at least one of the first outlet 714 and the second outlet 716 of the solenoid diverter 708. The solenoid diverter 708 is communicatively coupled to the system controller 230 such that a user interaction with a controller, such as the user interface controller 200, controls operation of the solenoid diverter 708. For example, a user interaction with the control puck 848 may configure the solenoid diverter 708 such that all of the water received via the inlet 712 is discharged from the solenoid diverter 708 via the first outlet 714 and water is prevented from flowing out of the second outlet 716. In some embodiments, a user interaction with the control puck 848 may cause 20% of the inlet flow to flow out of the first outlet 714, and allow 80% of the inlet flow to flow out of the second outlet 716. In some embodiments, the solenoid diverter 708 is a passive connector that does not include a valve or a valve assembly.

The water treatment system 704 further includes a treatment device, shown as a variable ozone generator 725, positioned downstream of the mixing valve 118 and positioned downstream of the solenoid diverter 708. In some embodiments, the treatment device is the treatment device 525. The variable ozone generator 725 is configured to receive a flow water from the second outlet 716 and selectively provide a treatment to the flow of water flowing through the variable ozone generator 725. In some embodiments, the variable ozone generator 725 is configured to actuate in response to a flow of water flowing through the variable ozone generator 725. For example, the variable ozone generator 725 may include the flow sensor 527 that measures a flow of water through the variable ozone generator 725 and/or a temperature of water flowing through the variable ozone generator 725 and/or a flow rate of water flowing through the variable ozone generator 725. In some embodiments, the variable ozone generator 75 is turned off in response to receiving a signal from the system controller 230 that the faucet controller (e.g., the handle control 116) is in an off position and/or that the system controller 230 received an off command from the faucet controller. When the faucet controller is operated to send an “on” signal to the system controller 230, the system controller 230 sends a signal to the solenoid diverter 708 to send 100% of the inlet flow of water through the second outlet 716, through the variable ozone generator 725, and through the fixture 102. At the same time that the system controller 230 sends the “on” signal to the solenoid diverter 708, the system controller 230 sends a signal to the variable ozone generator 725 to enter a “stand-by” mode, where the flow sensor 527 detects a flow rate and a temperature of water flowing through the variable ozone generator 725. In some embodiments, the variable ozone generator 725 is configured to operate in response to a flow rate of water and/or a temperature of water. For example, ozonation of the water by the variable ozone generator 725 may be directly proportional to the temperature of the water detected by the flow sensor 527, and may be inversely proportional to the flow rate of the water flowing through the variable ozone generator 725 and detected by the flow sensor 527. In some embodiments, the ozone concentration generated by the variable ozone generator 725 is 0.1 parts per million (PPM). When the flow sensor 527 detects and optimal flow of water flowing through the variable ozone generator 725, the variable ozone generator 725 may be limited to ozonated the water up to a concentration of 0.5 PPM. In some embodiments, as outlined above, the user may manually adjust the variable ozone generator 725 using the user interface controller 200.

In some embodiments, the flow sensor 527 measures a concentration of ozone in the flow of water and adjusts the output of the variable ozone generator 725 in response to a measurement of the concentration of the flow of water. For example, during the life time of the variable ozone generator 725, the electrodes may become coated in insolvable salts. As the electrodes become coated, the variable ozone generator 725 may require a greater voltage output to deliver the desired concentration than was required earlier in the life time of the variable ozone generator 725. Accordingly, the flow sensor 527 may directly measure the concentration outlet of the variable ozone generator 725 and automatically adjust the output voltage of the variable ozone generator 725 to achieve the desired concentration received from the user interface controller 200 (e.g., the control puck 848, the faucet controller 540, 560, 570, etc.).

In some embodiments, the water treatment system 704 includes a temperature sensor 730 positioned upstream of the solenoid diverter 708 and downstream of the mixing valve 118. The temperature sensor 730 is configured to measure a temperature of the water provided by the mixing valve 118 to the solenoid diverter 708, and the temperature sensor 730 sends the measurement to the system controller 230. The system controller 230 is configured to control operation of the solenoid diverter 708 and the variable ozone generator 725 in response to receiving the temperature measurement from the temperature sensor 730. For example, if the temperature measured by the temperature sensor 730 is below a threshold temperature, the system controller 230 may prevent the solenoid diverter 708 from providing a flow of water via the second outlet 716, and thus prevent a flow of water from flowing through the variable ozone generator 725. In some embodiments, the system controller 230 further operates the user interface controller 200 to prevent operation of the solenoid diverter 708, such as by disabling an option on the control puck 848. It may be advantageous to provide the temperature sensor 730 upstream of the solenoid diverter 708 to prevent an undesirable flow of water (e.g., too hot, too cold) from flowing through the variable ozone generator 725 before being measured by the flow sensor 527.

In some embodiments, the water treatment system 704 includes a pressure sensor 732 positioned upstream of the solenoid diverter 708 and downstream of the mixing valve 118. The pressure sensor 732 is configured to measure a pressure of the water flowing through the conduit positioned between the mixing valve 118 and the solenoid diverter 708, and the pressure sensor 732 sends the measurement to the system controller 230. The system controller 230 is configured to control operation of the solenoid diverter 708 and the variable ozone generator 725 in response to receiving the pressure measurement from the pressure sensor 732. For example, if the pressure measured by the pressure sensor 732 is below a threshold pressure, the system controller 230 may prevent the solenoid diverter 708 from providing a flow of water via the second outlet 716, and thus prevent a flow of water from flowing through the variable ozone generator 725. For example, in embodiments where the variable ozone generator 725 relies on water pressure to power the corona discharge required for ozonating water, the solenoid diverter 708 may determine that the water pressure provided by the mixing valve 118 is too low to power the variable ozone generator 725 and thus prevent a flow of water from flowing to the variable ozone generator 725. In some embodiments, the system controller 230 further operates the user interface controller 200 to prevent operation of the solenoid diverter 708, such as by disabling an option on the control puck 848 (e.g., greying out a word, preventing rotation of the dial 850, etc.). It may be advantageous to provide the pressure sensor 732 upstream of the solenoid diverter 708 to prevent an undesirable flow of water (e.g., too high pressure, too low pressure) from flowing through the variable ozone generator 725 before being measured by the flow sensor 527. In some embodiments, the pressure sensor 732 is configured to measure leaks within the water treatment system 704, such as between the mixing valve 118 and the solenoid diverter 708.

In some embodiments, the water treatment system 704 further includes a flow sensor 734 positioned upstream of the solenoid diverter 708 and downstream of the mixing valve 118. The flow sensor 734 is configured to measure a flow rate (e.g., gallons per minute, etc.) of the water flowing through the conduit positioned between the mixing valve 118 and the solenoid diverter 708, and the flow sensor 734 sends the measurement to the system controller 230. The system controller 230 is configured to control operation of the solenoid diverter 708 and the variable ozone generator 725 in response to receiving the flow rate measurement from the pressure sensor 732. For example, if the flow rate measured by the flow sensor 734 is below a threshold flow rate, the system controller 230 may prevent the solenoid diverter 708 from providing a flow of water via the second outlet 716, and thus prevent a flow of water from flowing through the variable ozone generator 725. For example, in embodiments where the flow rate is too high to safely ozonate the water, the system controller 230 may prevent a flow of water from flowing to the variable ozone generator 725. In some embodiments, the system controller 230 further operates the user interface controller 200 to prevent operation of the solenoid diverter 708, such as by disabling an option on the control puck 848 (e.g., greying out a word, preventing rotation of the dial 850, etc.). It may be advantageous to provide the flow sensor 734 upstream of the solenoid diverter 708 to prevent an undesirable flow of water (e.g., too much water, too little water) from flowing through the variable ozone generator 725 before being measured by the on-board flow sensor 527.

Fluidly coupled to the solenoid diverter 708 are a first flow path 740 and a second flow path 742. The first flow path 740 receives a flow of water from the first outlet 714 and provides the flow of water to the spray head of the first fixture 402. In some embodiments, the first flow path 740 is a pull-down hose (e.g., retractable hose) that extends through the neck 112 of the fixture 102. The second flow path 742 receives a flow of water from both the second outlet 716 and the variable ozone generator 725. The second flow path 742 is configured to provide the flow of water to one of a first fixture (e.g., the fixture 102, the first fixture 402) or a second fixture (e.g., the second fixture 403). The second flow path 742 may be a pull-down hose (e.g., retractable hose) that extends through the neck 112 of the fixture 102. In some embodiments, the second flow path 742 is a retractable hose that provides a flow of water to a side sprayer that retracts into an opening in the surface 101, such as the second fixture 403. In some embodiments, the first flow path 740 and the second flow path 742 both provide a flow of water to the spray head 114 of the first fixture 402 and both the first flow path 740 and the second flow path 742 are fluidly isolated from one another such that there is no contamination of flow paths between the non-treated water provided via the first flow path and the treated flow of water provided by the second flow path 742. In some embodiments, the spray head 114 includes a first outlet fluidly coupled to the first flow path 740 and a second outlet fluidly coupled to the second flow path 742, where the firset outlet and the second outlet are fluidly isolated from one another such that there is no mixing between the flows of water provided by the first flow path 740 and the second flow path 742. In some embodiments, the first flow path 740 and the second flow path 742 are in fluid communication at a position downstream of the variable ozone generator 725 and upstream of the spray head 114. In some embodiments, the first flow path 740 and the second flow path 742 are in fluid communication at a position within the spray head 114. For example, both the first flow path 740 and the second flow path 742 may be discharged from the spray head 114 via the same outlet. In some embodiments, the first flow path 740 and the second flow path 742 never mix, such as when the first flow path 740 receives a flow of water from the solenoid diverter 708 and provides the flow of water to the first fixture 402, and when the second flow path 742 received a flow of water from the variable ozone generator 725 and provides the flow of water to the second fixture 403.

As utilized herein with respect to numerical ranges, the terms “approximately,” “about,” “substantially,” and similar terms generally mean +/−10% of the disclosed values, unless specified otherwise. As utilized herein with respect to structural features (e.g., to describe shape, size, orientation, direction, relative position, etc.), the terms “approximately,” “about,” “substantially,” and similar terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above.

It is important to note that any element disclosed in one embodiment may be incorporated or utilized with any other embodiment disclosed herein. For example, the second fixture 403 of the exemplary embodiment described in at least paragraphs [0082]-[0087] may be incorporated in any of the faucet systems 100, 300, 400 of the exemplary embodiments described in at least paragraphs [0076]-[0080]. Although only one example of an element from one embodiment that can be incorporated or utilized in another embodiment has been described above, it should be appreciated that other elements of the various embodiments may be incorporated or utilized with any of the other embodiments disclosed herein.

What is claimed is:

1. A faucet system comprising:
a water treatment system comprising:
a treatment device configured to selectively provide a treatment to a flow of water, and
a system controller in communication with the treatment device;
a fixture fluidly coupled to the water treatment system and configured to receive the flow of water from the water treatment system; and
a user interface controller communicatively coupled to the system controller and configured to:
send a first input to the system controller, the first input comprising instructions for operating the treatment device; and
send a second input to the system controller, the second input causing:
initiation of the flow of water through the fixture, and
operation of the treatment device according to the instructions of the first input.

2. The faucet system of claim 1, wherein the first input includes instructions to activate the treatment device in response to receiving the second input.

3. The faucet system of claim 1, wherein the first input includes instructions to activate the treatment device after a time delay in response to receiving the second input.

4. The faucet system of claim 1, wherein:
the treatment device includes a flow sensor in communication with the system controller and configured to detect a flow of water through the treatment device, and
the system controller is configured to prevent activation of the treatment device if the flow sensor detects no water is flowing through the treatment device.

5. The faucet system of claim 1, wherein the fixture is a faucet having a base, a neck, and a pull-out spray head.

6. The faucet system of claim 5, further comprising a handle controller operably coupled to the base of the faucet and positionable between a first position and a second position, the handle controller including a handle sensor in communication with the system controller,
wherein the handle sensor sends the second input to the system controller when the handle controller is moved out of the first position.

7. The faucet system of claim 1, wherein in the user interface controller includes a first interface and a second interface, the first interface configured to send the first input and the second interface configured to send the second input.

8. The faucet system of claim 7, wherein both the first interface and the second interface are operably coupled to the fixture.

9. The faucet system of claim 7, wherein the first interface is positioned on a spray head of the fixture and the second interface is positioned on a base of the fixture.

10. The faucet system of claim 7, wherein the first interface is a control puck and the second interface is a handle controller operably coupled to the fixture.

11. The faucet system of claim 7, wherein the user interface controller is a control puck having both the first interface and the second interface.

12. A faucet system comprising:
a fixture comprising:
a handle controller; and
a spray head having an outlet and configured to discharge a flow of water;
a treatment device in fluid communication with the spray head and configured to selectively output a treatment to a flow of water;
a user interface controller; and
a system controller in communication with the handle controller, the treatment device, and the user interface controller;
wherein the system controller is configured to:
receive a first signal from the user interface controller;
in response to receiving the first signal, determine whether to activate the treatment device in response to receipt of a second signal;
receive the second signal from the handle controller; and
in response to receiving the second signal, operate the faucet system to do at least one of the following:
discharge an untreated flow of water from the fixture;
activate the treatment device and discharge a treated flow of water from the fixture; or
discharge an untreated flow of water from the fixture for a first time interval, activate the treatment device at an end of the first time interval, and discharge a flow of treated water from the fixture for a second time interval.

13. The faucet system of claim 12, wherein the user interface controller is positioned on the fixture.

14. The faucet system of claim 13, wherein the user interface controller is a module interface positioned on the spray head.

15. The faucet system of claim 12, wherein the user interface controller is a control puck separate from the fixture and in wireless communication with the system controller.

16. A faucet system comprising:
a fixture comprising:
a base configured for coupling to a mounting surface, and
a neck coupled to the base;
a hose extending through the neck and the base, the hose having a handle portion coupled to an end of the hose, and the hose configured to provide a flow of water to the handle portion; and
an enhancement module removably coupled to the handle portion, the enhancement module configured to receive a flow of water from the hose and configured to selectively provide a treatment to the flow of water.

17. The faucet system of claim 16, wherein the enhancement module includes a module interface configured to selectively control a treatment mode of the enhancement module.

18. The faucet system of claim 16, further comprising an electrical conduit that extends along the hose, wherein the handle portion is removably coupled to the enhancement module via a fitting, the fitting configured to fluidly couple the handle portion and the enhancement module, and the fitting configured to electrically couple the enhancement module to a system controller.

19. The faucet system of claim 18, further comprising a user interface controller in communication with the system controller and configured to selectively provide the system controller with instructions for operating the enhancement module.

20. The faucet system of claim 19, wherein the user interface controller is in wireless communication with the system controller and the user interface controller is separate from the fixture.
